(19) United States
(12) Patent Application Publication
(10) Pub. No.: US 2026/0113718 A1
(43) Pub. Date: Apr. 23, 2026

(54) UPLINK TRANSMISSION METHOD AND APPARATUS, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Zuomin WU, Dongguan (CN); Yi HU, Dongguan (CN); Haitao LI, Dongguan (CN); Nande ZHAO, Dongguan (CN); Xinlei YU, Dongguan (CN)

(73) Assignee: GUANGDONG OPPO MOBILE TELECOMMUNICATIONS CORP., LTD., Dongguan (CN)

(21) Appl. No.: 18/926,855

(22) Filed: Oct. 25, 2024

Related U.S. Application Data
(63) Continuation of application No. PCT/CN2022/090587, filed on Apr. 29, 2022.

(51) Int. Cl. H04W 56/00; H04W 84/06

(52) U.S. Cl. CPC H04W 56/001; H04W 56/0045; H04W 84/06

(57) ABSTRACT

Embodiments of this application provide an uplink transmission method and apparatus, a terminal device, and a network device. The method includes: determining, by a terminal device based on a first segment length, a segment TDW corresponding to a target uplink channel, where the target uplink channel includes N uplink channels, the segment TDW is associated with a time interval at which the terminal device performs time domain synchronization and/or frequency domain synchronization, and N is a positive integer; and sending, by the terminal device, the target uplink channel based on the segment TDW.

### CROSS-REFERENCE TO RELATED APPLICATIONS

This application is a continuation of International Application No. PCT/CN2022/090587, filed on Apr. 29, 2022, the disclosure of which is hereby incorporated by reference in its entirety.

### TECHNICAL FIELD

Embodiments of this application relate to the technical field of mobile communications, and specifically, to an uplink transmission method and apparatus, a terminal device, and a network device.

### BACKGROUND

Communication system scenarios are classified into terrestrial networks (TN) and non-terrestrial networks (NTN). In the NTN, satellites generally provide communication services to terrestrial terminal devices.

In the NTN, due to NTN network characteristics such as long signal propagation delay and satellite mobility combined with insufficient transmission power of a terminal device, uplink coverage of the terminal device is relatively weak. In the TN, coverage enhancement can be performed by using DMRS bundling-based joint channel estimation. However, there is currently no definite approach for applying this coverage enhancement technology in NTN networks.

### SUMMARY

Embodiments of this application provide an uplink transmission method and apparatus, a terminal device, and a network device.

According to a first aspect, an uplink transmission method is provided, and the method includes: determining, by a terminal device based on a first segment length, a segment time domain window (STDW, or segment TDW for short) corresponding to a target uplink channel, where the target uplink channel includes N uplink channels, the segment TDW is associated with a time interval at which the terminal device performs time domain synchronization and/or frequency domain synchronization, and N is a positive integer; and sending, by the terminal device, through the target uplink channel based on the segment TDW.

According to a second aspect, an uplink transmission method is provided, and the method includes: receiving, by a network device, transmissions through a target uplink channel, where the target uplink channel includes N uplink channels, N is a positive integer, the target uplink channel is transmitted in a segment TDW, the segment TDW is determined based on a first segment length, and the segment TDW is associated with a time interval at which a terminal device performs time domain synchronization and/or frequency domain synchronization.

According to a third aspect, an uplink transmission apparatus is provided, applied to a terminal device, and including: a first determining unit, configured to determine, based on a first segment length, a segment TDW corresponding to a target uplink channel, where the target uplink channel includes N uplink channels, the segment TDW is associated with a time interval at which the terminal device performs time domain synchronization and/or frequency domain synchronization, and N is a positive integer; and a first sending unit, configured to send the target uplink channel based on the segment TDW.

According to a fourth aspect, an uplink transmission apparatus is provided, applied to a network device, and including: a second receiving unit, configured to receive transmissions through a target uplink channel, where the target uplink channel includes N uplink channels, the target uplink channel is transmitted in a plurality of segment TDWs, the plurality of segment TDWs are determined based on a first segment length, the segment TDW is associated with a time interval at which a terminal device performs time domain synchronization and/or frequency domain synchronization, and N is a positive integer.

According to a fifth aspect, an embodiment of this application provides a terminal device, including a processor and a memory. The memory is configured to store a computer program, and the processor is configured to invoke and run the computer program stored in the memory, to perform the uplink transmission method according to the first aspect.

According to a sixth aspect, an embodiment of this application provides a network device, including a processor and a memory. The memory is configured to store a computer program, and the processor is configured to invoke and run the computer program stored in the memory, to perform the uplink transmission method according to the second aspect.

According to a seventh aspect, an embodiment of this application provides a chip, configured to implement the uplink transmission method described above. Specifically, the chip includes a processor, configured to invoke a computer program from a memory and run the computer program, to cause a device installed with the chip to perform the uplink transmission method described above.

According to an eighth aspect, an embodiment of this application provides a computer-readable storage medium, configured to store a computer program, where the computer program causes a computer to perform the uplink transmission method described above.

According to a ninth aspect, an embodiment of this application provides a computer program product, including computer program instructions, and the computer program instructions cause a computer to perform the uplink transmission method described above.

According to a tenth aspect, an embodiment of this application provides a computer program. When the computer program is run on a computer, the computer is caused to perform the uplink transmission method described above.

In the uplink transmission method provided in embodiments of this application. A terminal device may determine, based on a first segment length, a segment TDW corresponding to a target uplink channel, where the segment TDW is associated with a time interval at which the terminal device performs time domain synchronization and/or frequency domain synchronization. Then, the terminal device may send a transmission through the target uplink channel based on the segment TDW. It may be understood that the segment TDW is associated with the time interval at which the terminal device performs time domain synchronization and/or frequency domain synchronization.

### BRIEF DESCRIPTION OF DRAWINGS

The drawings described herein are used to provide a further understanding of this application and constitute a part of this application. Illustrative embodiments of this application and descriptions thereof are used to explain this application and do not constitute improper limitations on this application. In the accompanying drawings:

FIG. 1 is a schematic diagram of an architecture of a communication system according to an embodiment of this application.

FIG. 2 is a schematic diagram of an architecture of another communication system according to an embodiment of this application.

FIG. 3 is a schematic diagram of an architecture of another communication system according to an embodiment of this application.

FIG. 4 is a schematic flowchart of an uplink transmission method according to an embodiment of this application.

FIG. 5 is a schematic diagram 1 of segment TDW distribution according to an embodiment of this application.

FIG. 6 is a schematic diagram 2 of segment TDW distribution according to an embodiment of this application.

FIG. 7 is a schematic diagram of distribution of segment TDWs and actual TDWs according to an embodiment of this application.

FIG. 8 is a schematic diagram 1 of distribution of segment TDWs and nominal TDWs according to an embodiment of this application.

FIG. 9 is a schematic diagram 2 of distribution of segment TDWs and nominal TDWs according to an embodiment of this application.

FIG. 10 is a schematic diagram of distribution of segment TDWs, nominal TDWs, and actual TDWs according to an embodiment of this application.

FIG. 11 is a schematic diagram 1 of an application time of a timing advance command according to an embodiment of this application.

FIG. 12 is a schematic diagram 2 of an application time of a timing advance command according to an embodiment of this application.

FIG. 13 is a schematic diagram 1 of a structure of an uplink transmission apparatus according to an embodiment of this application.

FIG. 14 is a schematic diagram 2 of a structure of an uplink transmission apparatus according to an embodiment of this application.

FIG. 15 is a schematic diagram of a structure of a communication device according to an embodiment of this application.

FIG. 16 is a schematic diagram of a structure of a chip according to an embodiment of this application.

FIG. 17 is a schematic block diagram of a communication system to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. All other embodiments obtained by persons of ordinary skill in the art based on embodiments of this application without creative efforts fall within the protection scope of this application. The technical solutions described in embodiments of this application may be combined arbitrarily without conflicts. In the description of this application, “a plurality of” means two or more than two, unless otherwise explicitly and specifically defined.

Communication system scenarios include terrestrial communication networks (TN) and non-terrestrial communication networks (NTN). An NTN may use satellite communications to provide communication services to terrestrial users. An NTN system may include a new radio (NR) NTN system and an internet of things (IOT) NTN system.

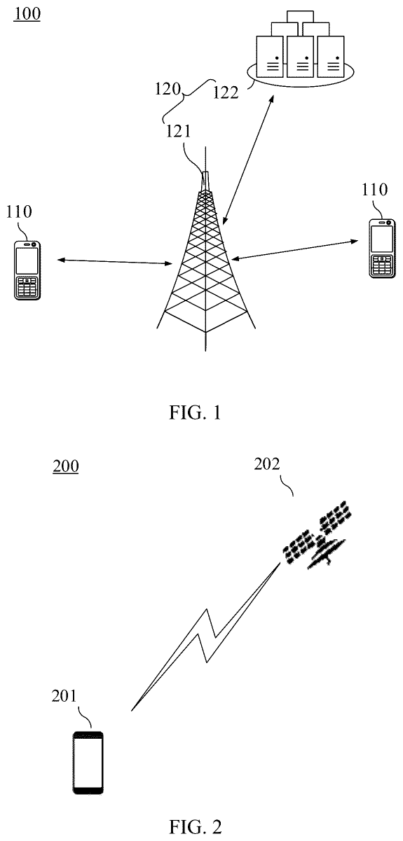

FIG. 1 is a schematic diagram of an architecture of a communication system according to an embodiment of this application. As shown in FIG. 1, a communication system 100 may be a terrestrial communication network system. The communication system 100 may include a terminal device 110 and a network device 120. The network device 120 may communicate with the terminal devices 110 by using air interfaces. Multi-service transmission is supported between the terminal devices 110 and the network device 120.

It should be understood that the communication system 100 is merely used as an example for description in this embodiment of this application, but this embodiment of this application is not limited thereto. That is, the technical solutions in embodiments of this application may be applied to various communication systems, for example, a long term evolution (LTE) system, an LTE time division duplex (TDD) system, a universal mobile telecommunication system (UMTS) system, an internet of things (IoT) system, a narrow band internet of things (NB-IoT) system, an enhanced machine-type communications (eMTC) system, a 5G communication system (also referred to as a new radio (NR) communication system), or a future communication system (such as a 6G or 7G communication system).

The network device 120 in this embodiment of this application may include an access network device 121 and/or a core network device 122. The access network device may provide communication coverage for a specific geographical area, and may communicate with a terminal device 110 (such as UE) located in the coverage.

The terminal device in this application may be referred to as user equipment (UE), a mobile station (MS), a mobile terminal (MT), a user unit, a user station, a mobile site, a remote station, a remote terminal, a mobile device, a user terminal, a terminal, a wireless communication device, a user agent, or a user apparatus. The terminal device may include one of the following or a combination of at least two of the following: an Internet of Things (IoT) device, a satellite terminal, a Wireless Local Loop (WLL) station, a Personal Digital Assistant (PDA), a handheld device having a wireless communication function, a computing device or another processing device connected to a wireless modem, a server, a mobile phone, a pad, a computer having a wireless transceiver capability, a palmtop computer, a desktop computer, a personal digital assistant, a portable media player, a smart speaker, a navigation apparatus, a wearable device such as a smart watch, smart glasses, or a smart necklace, a pedometer, a digital TV, a Virtual Reality (VR) terminal device, an Augmented Reality (AR) terminal device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, or a vehicle, an in-vehicle device, an in-vehicle module, a wireless modem, a handheld device, a Customer Premise Equipment (CPE), or a smart home appliance in a vehicle-to-everything system.

Optionally, the terminal device 110 may be any terminal device, which includes but is not limited to a terminal device that is connected to the network device 120 or another terminal device by using a wired or wireless connection.

Optionally, the terminal device 110 may be used for device to device (D2D) communication.

The access network device 121 may include one of the following or a combination of at least two of the following: an evolved NodeB (evolved NodeB, eNB or eNodeB) in a long term evolution (LTE) system, or a next generation radio access network (NG RAN) device, or a gNB in an NR system, a small cell, a micro base station, or a wireless controller in a cloud radio access network (CRAN), a wireless-fidelity (Wi-Fi) access point, a transmission reception point (TRP), a relay station, an access point, an in-vehicle device, a wearable device, a hub, a switch, a bridge, a router, or a network device in a future evolved public land mobile network (PLMN).

The core network device 122 may be a 5G core network (5G Core, 5GC) device. For example, the core network device 122 may include at least one of the following or a combination of at least two of the following: an access and mobility management function (AMF), an authentication server function (AUSF), a user plane function (UPF), or fa session management function (SMF), or a location management function (LMF). In some other embodiments, the core network device may also be an evolved packet core (EPC) device of an LTE network, for example, a session management function+packet gateway of a core network (SMF+PGW-C) device. It should be understood that the SMF+PGW-C may implement both a function that can be implemented by an SMF and a function that can be implemented by a PGW-C. In a network evolution process, the foregoing core network device 122 may also be referred to as another name, or a new network entity may be formed by dividing a function of the core network, which is not limited in this embodiment of this application.

Communication between functional units in the communication system 100 may be further implemented by establishing a connection through a next generation (NG) interface.

For example, the terminal device establishes an air interface connection to an access network device by using an NR interface, to transmit user plane data and control plane signaling. The terminal device may establish a control plane signaling connection to an AMF by using an NG interface 1 (N1 for short). The access network device, for example, a next-generation radio access base station (gNB), may establish a user plane data connection to a UPF by using an NG interface 3 (N3 for short). The access network device may establish a control plane signaling connection to the AMF by using an NG interface 2 (N2 for short). The UPF may establish a control plane signaling connection to an SMF by using an NG interface 4 (N4 for short). The UPF may exchange user plane data with a data network by using an NG interface 6 (N6 for short). The AMF may establish a control plane signaling connection to the SMF by using an NG interface 11 (N11 for short). The SMF may establish a control plane signaling connection to a PCF by using an NG interface 7 (N7 for short).

FIG. 1 exemplarily shows a base station, a core network device, and two terminal devices. Optionally, the wireless communication system 100 may include a plurality of base station devices, and another quantity of terminal devices may be included within coverage of each base station. This is not limited in this embodiment of this application.

The 3GPP is studying a non-terrestrial communication network device (NTN) technology. An NTN generally uses satellite communications to provide communication services to terrestrial users. Compared with terrestrial cellular network communications, satellite communications have many unique advantages. First, satellite communications are not restricted by geographical locations of users. For example, terrestrial communications generally cannot cover oceans, mountains, deserts, or other areas in which communication devices cannot be set up or there is no communication coverage due to sparse population. For satellite communications, because one satellite can cover a larger area and the satellite can orbit the earth, in theory every corner of the earth can be covered by satellite communications. Second, satellite communications have great social value. Satellite communications can be covered at a relatively low cost in remote mountainous areas, and poor and backward countries or regions, allowing people in these areas to enjoy advanced voice communications and mobile Internet technologies, which helps narrow the digital divide with developed areas and promote development of these areas. Third, satellite communications have a long distance, and costs of communication do not increase significantly as a communication distance increases. Finally, satellite communications have high stability and are not restricted by natural disasters.

The NTN technology may be combined with various communication systems. For example, the NTN technology may be combined with an NR system to form an NR-NTN system. For another example, the NTN technology may be combined with an IoT system to form an IoT-NTN system. In an example, the IoT-NTN system may include an NB-IoT-NTN system and an eMTC-NTN system.

FIG. 2 is a schematic diagram of an architecture of another communication system according to an embodiment of this application. As shown in FIG. 2, a communication system 200 in FIG. 2 may be a non-terrestrial communication network system. The communication system 200 includes a terminal device 201 and a satellite 202. Wireless communication may be performed between the terminal device 201 and the satellite 202. A network formed between the terminal device 201 and the satellite 202 may also be referred to as an NTN. In the architecture of the communication system 200 shown in FIG. 2, the satellite 202 may have a function of a base station, and direct communication may be performed between the terminal device 201 and the satellite 202. In the system architecture, the satellite 202 may be referred to as a network device. In some embodiments of this application, the communication system 200 may include a plurality of network devices 202, and another quantity of terminal devices may be included in coverage of each network device 202, which is not limited in this embodiment of this application.

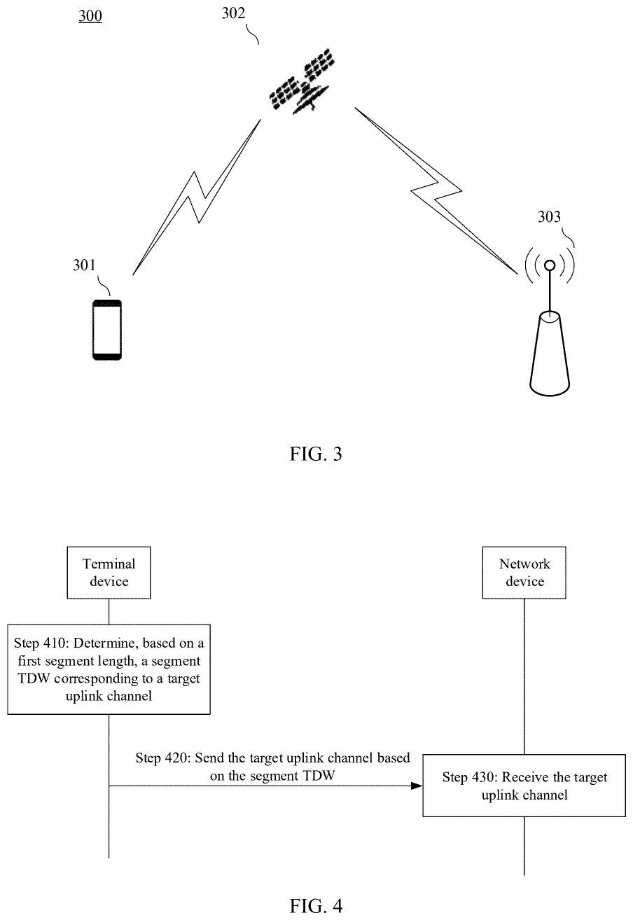

FIG. 3 is a schematic diagram of an architecture of another communication system according to an embodiment of this application. As shown in FIG. 3, a communication system 300 in FIG. 3 may be a non-terrestrial communication network system. The communication system 300 includes a terminal device 301, a satellite 302, and a base station 303. Wireless communication may be performed between the terminal device 301 and the satellite 302, and communication may be performed between the satellite 302 and the base station 303. A network formed between the terminal device 301, the satellite 302, and the base station 303 may also be referred to as an NTN. In the architecture of the communication system 300 shown in FIG. 3, the satellite 302 may not have a function of a base station, and communication between the terminal device 301 and the base station 303 requires relaying through the satellite 302. In such a system architecture, the base station 303 may be referred to as a network device. In some embodiments of this application, the communication system 300 may include a plurality of network devices 303, and another quantity of terminal devices may be included in coverage of each network device 303, which is not limited in this embodiment of this application. The network device 303 may be the network device 120 in FIG. 1.

It should be understood that the foregoing satellite 202 or satellite 302 includes but is not limited to: a low-earth orbit (LEO) satellite, a medium-earth orbit (MEO) satellite, a geostationary earth orbit (GEO) satellite, a high elliptical orbit (HEO) satellite, or the like. A satellite may use a plurality of beams to cover the ground. For example, a satellite may generate dozens or even hundreds of beams to cover the ground. In other words, a satellite beam may cover a terrestrial area with a diameter of tens of kilometers to more than a hundred of kilometers to ensure satellite coverage and improve system capacity of an entire satellite communication system.

In an example, an altitude of a LEO satellite may range from 500 km to 1500 km, and a corresponding orbital period may be approximately 1.5 hours to 2 hours. A signal propagation delay of single-hop communication between users may generally be less than 20 milliseconds, and a maximum satellite visible time may be 20 minutes. A LEO satellite has a short signal propagation distance and a small link loss, and a transmit power requirement for a user terminal is not high. An orbital altitude of a GEO satellite may be 35,786 km, and its period of rotation around the earth may be 24 hours. A signal propagation delay of single-hop communication between users is generally 250 milliseconds.

To ensure satellite coverage and improve system capacity of the entire satellite communication system, a satellite uses a plurality of beams to cover the ground, and one satellite may use generate dozens or even hundreds of beams to cover the ground. A satellite beam may cover a terrestrial area with a diameter of tens of kilometers to a hundred of kilometers.

It should be noted that FIG. 1 to FIG. 3 show merely examples of systems to which this application is applicable. Certainly, the method in embodiments of this application may also be applicable to other systems. In addition, the terms “system” and “network” in the specification may often be used interchangeably. In this specification, the term “and/or” is merely an association relationship that describes associated objects, and represents that there may be three relationships. For example, A and/or B may represent three cases: only A exists, both A and B exist, and only B exists. In addition, the character “/” in the specification generally indicates an “or” relationship between the associated objects. It should be further understood that, the “indication” mentioned in embodiments of this application may be a direct indication or an indirect indication, or indicate an association. For example, A indicates B, which may mean that A directly indicates B, for example, B may be obtained by means of A; or may mean that A indirectly indicates B, for example, A indicates C, and B may be obtained by means of C; or may mean that there is an association relationship between A and B. It should be further understood that the term “corresponding” mentioned in embodiments of this application may mean that there is a direct or indirect correspondence between two elements, or that there is an association between two elements, or that there is a relationship of “indicating” and “being indicated”, “configuring” and “being configured”, or the like. It should be further understood that, the terms “predefined”, “agreed upon by a protocol”, “predetermined”, or “predefined rule” mentioned in embodiments of this application may be implemented by prestoring corresponding code, tables, or other forms that may be used to indicate related information in devices (for example, including a terminal device and a network device), and a specific implementation thereof is not limited in this application. For example, being pre-defined may refer to being defined in a protocol. It should be further understood that in embodiments of this application, the “protocol” may refer to a standard protocol in the communication field, for example, may include an LTE protocol, an NR protocol, and a related protocol applied to a future communication system. This is not limited in this application.

For ease of understanding of the technical solutions in embodiments of this application, the following describes related technologies in embodiments of this application. The following related technologies, as optional solutions, may be randomly combined with the technical solutions of embodiments of this application, all of which fall within the protection scope of embodiments of this application.

1. Synchronization technology in NTN system: In an NTN system, a network device needs to send synchronization assistance information to a terminal device, where the synchronization assistance information is used by the terminal device to implement time domain synchronization and/or frequency domain synchronization. The synchronization assistance information may include at least one of the following: serving satellite ephemeris information, a common timing advance (TA) parameter, reference time indication information (epoch time, used to determine time t0), or duration of a target timer.

Optionally, the terminal device may implement corresponding time domain synchronization and/or frequency domain synchronization based on the synchronization assistance information and a global navigation satellite system (GNSS) capability of the terminal device. For example, the terminal device may obtain at least one of the following based on the GNSS capability of the terminal device: a position of the terminal device, a time reference, or a frequency reference. Then, the terminal device may obtain timing and/or a frequency offset based on the foregoing information and the synchronization assistance information, and apply timing advance compensation and/or frequency offset adjustment in different states (idle state, inactive state, or connected state).

Optionally, the terminal device may calculate a T_{TA} value according to the following formula (1), and determine timing of uplink channel or uplink signal transmission based on the determined T_{TA} value:

$${T}_{TA} = ( {N}_{TA} + {N}_{TA , offset} + {N}_{TA , adj}^{common} + {N}_{TA , adj}^{UE} ) * Tc \qquad ( 1 )$$

If an uplink channel includes a PRACH or MsgA transmission, the N_{TA} value is 0; otherwise N_{TA} is a TA value indicated by the network device. N_{TA,offset} is determined based on a network deployment frequency band and coexistence with LTE or NR. N_{TA,adj}^{common} is obtained based on public timing parameters (such as a common timing value, a common timing value offset, and a change rate of a common timing value offset) configured by a higher layer. If common TA parameters are not configured by the higher layer, N_{TA,adj}^{common} is set to 0. N_{TA,adj}^{UE} is calculated by the terminal device based on a location of the terminal device and serving satellite ephemeris information configured by the higher layer. If the serving satellite ephemeris information is not configured by the higher layer, N_{TA,adj}^{UE} is set to 0. Tc represents a sampling time interval unit, where Tc=1/(480*1000*4096).

Optionally, because the synchronization assistance information may change over time, one or more timers need to be configured for the terminal device in the NTN system. The one or more timers may be used by the terminal device to determine whether the obtained synchronization assistance information is valid. For example, the synchronization assistance information may correspond to a target timer. After the terminal device starts or restarts the target timer, before the target timer expires (or before a duration of the target timer ends), the terminal device may assume that the synchronization assistance information obtained by the terminal device is valid.

In actual application, serving satellite ephemeris information in the synchronization assistance information is used to determine position and velocity state (PVS) vector information of a serving satellite. The serving satellite ephemeris information in the synchronization assistance information may include at least one of the following two formats:

Format 1: Ephemeris information format based on an instantaneous state vector, such as a PVS vector of the satellite at a specific moment. In this manner, the satellite ephemeris information includes a geocentric coordinate system-based PVS vector (S_{X}, S_{Y}, S_{Z}, V_{X}, V_{Y}, V_{Z}) at time t0.

By way of example rather than limitation, the terminal device obtains, based on the geocentric coordinate system-based PVS vector of the satellite at time t0, a geocentric coordinate system-based PVS vector of the satellite at time t.

Format 2: Ephemeris information format based on orbit information. In this manner, the satellite ephemeris information includes ephemeris parameters (α(km), e, I(deg), Ω(deg), ω(deg), M(deg)) at time t0. Herein, α represents a semi-major axis (which may be measured in meters), e represents an eccentricity, ω represents an argument of periapsis (which may be measured in rad (radian angle)), Ω represents a longitude of ascending node (which may be measured in rad), i represents an inclination (which may be measured in rad), and M represents a mean anomaly M at epoch time t0 (which may be measured in rad).

By way of example rather than limitation, the terminal device may obtain an earth-centered, earth-fixed (ECEF) coordinate system (also called the geocentric coordinate system)-based PVS vector of the satellite at time t0 based on the received ephemeris parameters at time t0. The terminal device may obtain, based on the geocentric coordinate system-based PVS vector of the satellite at time t0, the geocentric coordinate system-based PVS vector of the satellite at time t.

By way of example rather than limitation, the terminal device obtains, based on the received ephemeris parameters of the satellite at time t0, ephemeris parameters of the satellite at time t; and then, the terminal device may obtain a geocentric coordinate system-based PVS vector of the satellite at time t based on the ephemeris parameters of the satellite at time t.

The geocentric coordinate system-based PVS vector includes (S_{X}, S_{Y}, S_{Z}, V_{X}, V_{Y}, V_{Z}). Herein, (S_{X}, S_{Y}, S_{Z}) corresponds to the position of the satellite, and is measured in m; (V_{X}, V_{Y}, V_{Z}) corresponds to a velocity of the satellite, and is measured in m/s.

For the two formats, a notification manner of Format 2 has less overheads than that of Format 1. However, in Format 2, the terminal device needs to perform modeling to estimate a PVS vector of the satellite, and therefore accuracy is lower than that of format 1.

In some embodiments of this application, the common timing advance TA parameter includes at least one of the following information: a common timing value (measured in μs), a common timing value offset (for example, a first-order derivative of a common timing value, measured in μs/s), a change rate of a common timing value offset (for example, a second-order derivative of a common timing value, measured in μs/s²).

Coverage enhancement technology in NR system: In an NR system, a coverage enhancement technology of demodulation reference signal (DMRS) bundling-based joint channel estimation is introduced. Target uplink channels to which this coverage enhancement technology can be applied include physical uplink shared channel (PUSCH) retransmission type A (which may be scheduled or preconfigured by DCI format 0_1 or DCI format 0_2), PUSCH retransmission type B, TB processing over multi-slot PUSCH (TBoMS), and physical uplink control channel (PUCCH) retransmission. In order to implement DMRS bundling-based joint channel estimation, enhancement is required in aspects such as power consistency and phase continuity, DMRSs in special slots, and time domain frequency hopping gaps of inter-slot frequency hopping using slot bundling.

The concepts of nominal time domain window (NTDW) and actual time domain window (ATDW) are introduced for joint channel estimation. One target uplink channel transmission may be covered by one or more nominal time domain windows, a length of a nominal time domain window other than a last nominal time domain window may be configured by a network device or predefined. One nominal time domain window may include one or more actual time domain windows. The terminal device needs to maintain power consistency and phase continuity within one actual time domain window. Correspondingly, the network device may perform DMRS joint channel estimation within one actual time domain window.

For example, in a nominal time domain window (referred to as nominal TDW for short), a start position of a 1^{st} actual time domain window (referred to as actual TDW for short) is a 1^{st} symbol of a 1^{st} PUSCH in the nominal TDW. If an event that destroys power consistency and phase continuity occurs, an end position of the actual TDW is a last symbol of a PUSCH transmission before the event occurs; otherwise, an end position of the actual TDW is a last symbol of a last PUSCH in the nominal TDW. When an event that destroys power consistency and phase continuity occurs, if the terminal device has a capability to restart DMRS bundling, a new actual TDW is created after the event ends; or if the terminal device does not have a capability to restart DMRS bundling, no new actual TDW is created until the nominal TDW ends. When the terminal device supports DMRS bundling, if power consistency and phase continuity are destroyed due to a semi-static event (for example, the event is not triggered by DCI or a MAC-CE), the terminal device needs to support DMRS bundling restarting; or if power consistency and phase continuity are destroyed due to a dynamic event (for example, the event is triggered by DCI or a MAC-CE), whether the terminal device supports DMRS bundling restarting is an optional capability.

The event that destroys power consistency and phase continuity includes at least one of the following: (1) in a time division duplex (TDD) spectrum, a downlink slot or downlink reception or downlink monitoring is determined based on a semi-static downlink/uplink configuration pattern; (2) for a normal cyclic prefix (CP), a gap between two consecutive uplink channel transmissions is greater than 13 symbols; and for an extended CP, a gap between two consecutive uplink channel transmissions is greater than 11 symbols; (3) a gap between two consecutive uplink channel transmissions is not greater than 13 symbols but another uplink transmission (or, for non-back-to-back PUSCH/PUCCH transmissions on a plurality of consecutive slots, another uplink transmission between two PUSCH/PUCCH transmissions) is scheduled in the gap; (4) based on a collision rule defined by a protocol, uplink channel transmission is discarded or canceled; (5) two consecutive PUSCH transmissions is associated with different UL beams (or, for a multi-TRP operation, if both DMRS bundling and UL beam switching are configured, for the multi-TRP operation, UL beam switching is an event that destroys power consistency and phase continuity, and the event is considered as a semi-static event); (6) two consecutive PUCCH transmissions are associated with different UL beams or different power control parameters (or, for a multi-TRP operation, a power control parameter change is also an event that destroys power consistency and phase continuity, and the event is considered as a semi-static event); (7) uplink TA adjustment after a TA command sent by the network device is received; (8) frequency hopping processing in frequency domain is performed; or (9) for reduced capability half-duplex frequency division duplex user equipment (RedCap HD-FDD UE), discarding or cancellation of PUSCH transmission occurs according to a protocol-defined discard rule; and/or there is a symbol overlapping with downlink reception/monitoring between two consecutive PUSCH transmissions (even if neither of the two repeated transmitted symbols overlaps with downlink reception/monitoring).

In the current NTN system, due to characteristics of NTN networks such as satellite mobility, there is a long delay in information transmission, which may lead to weak coverage of the terminal device. In an evolved NTN network, a coverage enhancement technology for the terminal device needs to be considered. For example, in an NTN network, a coverage enhancement technology of DMRS bundling-based joint channel estimation may be introduced. However, how to apply this coverage enhancement technology in an NTN system is not clear currently.

It should be understood that the coverage enhancement technology of DMRS bundling-based joint channel estimation requires the terminal device to support uplink retransmission. Introduction of uplink retransmission causes a relatively long transmission time of a target uplink channel of the terminal device. Because a satellite in the NTN system is always in a moving state, if the terminal device does not perform time domain synchronization and/or frequency domain synchronization during transmission of the target uplink channel, uplink synchronization of the terminal device may fail to meet an accuracy requirement. However, the coverage enhancement technology of DMRS bundling-based joint channel estimation requires the terminal device to maintain power consistency and phase continuity over a period of time. If the terminal device frequently performs time domain synchronization and/or frequency domain synchronization during transmission of the target uplink channel, the network device may be incapable of determining an occasion on which the terminal device performs uplink synchronization, thereby reducing a gain of DMRS bundling-based joint channel estimation. Therefore, in the NTN system, how to ensure the gain of joint channel estimation while meeting a synchronization accuracy requirement is an urgent problem to be resolved.

To resolve the foregoing problem, an embodiment of this application provides an uplink transmission method. Refer to a flowchart shown in FIG. 4. An uplink transmission method provided in an embodiment of this application may include the following steps.

Step 410: A terminal device determines, based on a first segment length, a segment time domain window (STDW, or segment TDW for short) corresponding to a target uplink channel, where the target uplink channel includes N uplink channels, N is a positive integer, the segment TDW is associated with a time interval at which the terminal device performs time domain synchronization and/or frequency domain synchronization.

Step 420: The terminal device sends through the target uplink channel based on the segment TDW.

Step 430: A network device receives transmissions through a target uplink channel, where the target uplink channel is transmitted in a segment TDW, the segment TDW is determined based on the first segment length, and the segment TDW is associated with a time interval at which the terminal device performs time domain synchronization and/or frequency domain synchronization.

It should be noted that the terminal device may be a terminal device in an NTN, and the corresponding network device is a network device in the NTN. In some embodiments, the terminal device may alternatively be a terminal device in a TN, and the corresponding network device is a network device in the TN, which is not limited in embodiments of this application.

In this embodiment of this application, the first segment length may be a time length or a length of time domain resources. A time unit of the first segment length may be one/more slots, or one/more subframes, or one/more symbols, or a transmission duration of one/more PUSCHs, or a transmission duration of one/more PUCCHs, or one/more milliseconds, or one/more microseconds, or the like, which is not limited in embodiments of this application.

It should be noted that the first segment length is predefined, or is determined according to a predefined rule, or is determined based on first configuration information sent by the network device, or is determined based on a segment length set configured by the network device, which is not limited in embodiments of this application.

Optionally, the first configuration information may be carried in at least one of the following information: a system message, radio resource control (RRC) signaling, a medium access control (MAC) control element (CE), or downlink control information (DCI).

Optionally, when the terminal device is in a connected state, the first configuration information is carried in RRC signaling specific to the terminal device (such as an RRC connection configuration message or an RRC connection reconfiguration message); and/or when the terminal device is in an idle state or an inactive state, the first configuration information is carried in a system message.

Optionally, when the first configuration information is configured through the RRC signaling specific to the terminal device, the terminal device determines the first segment length based on the first configuration information in the RRC signaling specific to the terminal device; otherwise, the terminal device determines the first segment length based on the first configuration information in the system message.

Optionally, the terminal device may alternatively determine the first segment length based on a predefined parameter or a predefined rule.

That is, the terminal device may calculate the first segment length by itself. The predefined parameter may be an attribute parameter or a capability parameter of the terminal device or the like, which is not limited in embodiments of this application. For example, the predefine parameter may include a minimum time interval at which the terminal device is capable of performing time domain synchronization and/or frequency domain synchronization and/or a maximum time interval at which the terminal device is capable of performing time domain synchronization and/or frequency domain synchronization.

The predefined rule may be a rule agreed upon by the terminal device and the network device, or defined in a protocol, which is not limited in embodiments of this application. For example, the predefined rule may be: using a maximum time interval at which the terminal device is capable of performing time domain synchronization and/or frequency domain synchronization as the first segment length, or using a minimum time interval at which the terminal device performs time domain synchronization and/or frequency domain synchronization as the first segment length.

In addition, the target uplink channel in this embodiment of this application may include N uplink channels, where N is an integer greater than or equal to 1. Optionally, the target uplink channel may be determined by using a time domain resource allocation indication. For example, the network device may send a time domain resource allocation indication to the terminal device, and the terminal device determines the target uplink channel based on the time domain resource allocation indication.

It should be noted that the time domain resource allocation indication may be a semi-static resource configuration indication (such as a PUSCH configuration grant configured through RRC signaling) or a dynamic resource allocation indication (such as an uplink grant through DCI), which is not limited in embodiments of this application.

Optionally, the target uplink channel may include at least one of the following: a PUSCH, a PUCCH, or a PRACH.

Optionally, when the PUSCH includes N uplink channels (for example, the target PUSCH includes N PUSCHs), the N uplink channels may include at least one of the following: PUSCH retransmission type A, PUSCH retransmission type B, and TB processing over multi-slot PUSCH (TBoMS).

PUSCH retransmission type A may be preconfigured or scheduled through DCI format 0_1 or DCI format 0_2, which is not limited in embodiments of this application.

Optionally, when the PUCCH includes N uplink channels (for example, a target PUCCH includes N PUCCHs), the N uplink channels may include PUCCH retransmissions.

In this embodiment of this application, the terminal device may divide a transmission duration of the target uplink channel into one or more segment TDWs based on the first segment length to obtain the segment TDW corresponding through the target uplink channel. That is, a transmission duration of the target uplink channel may be covered by at least one segment TDW.

It should be understood that the first segment length may be used by the terminal device to perform time domain synchronization and/or frequency domain synchronization. The segment TDW that is determined based on the first segment length and that corresponds through the target uplink channel may be associated with a time interval at which the terminal device performs time domain synchronization and/or frequency domain synchronization. For example, a length of the segment TDW may be greater than a minimum time interval at which the terminal device performs time domain synchronization and/or frequency domain synchronization, or a length of the segment TDW may be less than a maximum time interval at which the terminal device is capable of performing time domain synchronization and/or frequency domain synchronization, which is not limited in embodiments of this application.

Further, after determining the segment TDW, the terminal device may perform time domain synchronization and/or frequency domain synchronization for the segment TDW, and send the target uplink channel after performing time domain synchronization and/or frequency domain synchronization.

In some embodiments, if a transmission duration of the target uplink channel corresponds to at least one segment TDW, that the terminal device sends the target uplink channel based on the segment TDW may be implemented in the following manner: before sending through the target uplink channel based on each of the at least one segment TDW, the terminal device performs time domain synchronization and/or frequency domain synchronization for the segment TDW.

That is, the terminal device may perform timing synchronization compensation and/or frequency offset synchronization compensation for each segment TDW, and after completing the timing synchronization compensation and/or the frequency offset synchronization compensation, send to an uplink channel corresponding to each segment TDW. This ensures accuracy of synchronization between the terminal device and the network device.

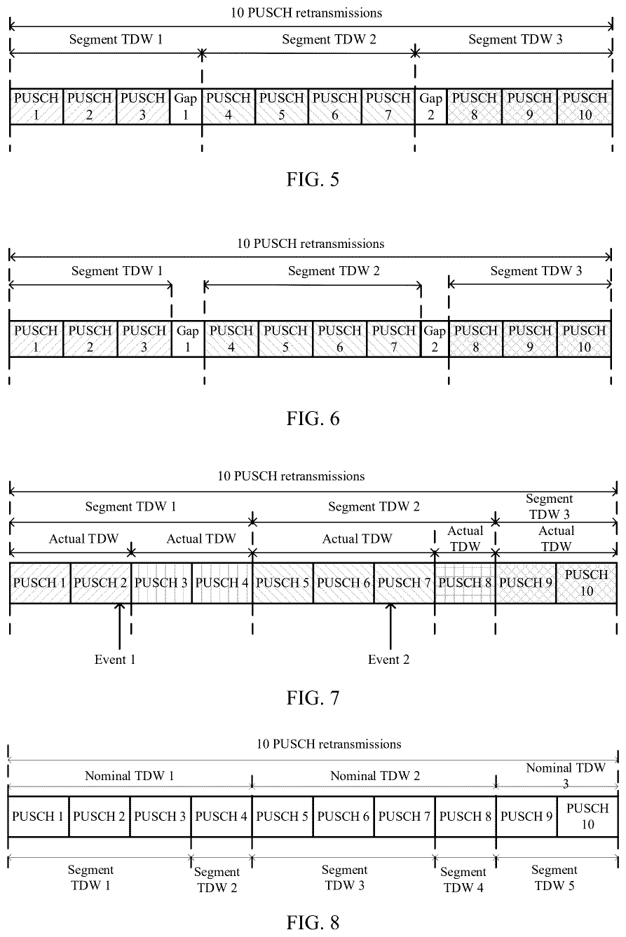

For example, as shown in FIG. 5, the target uplink channel may include 10 PUSCH retransmissions and 2 channel gaps (GAP), where each PUSCH occupies one slot and each GAP also occupies one time slot, that is, the target uplink channel may include 12 slots. Assuming that the first segment length is 4 slots, a transmission duration of the target uplink channel may be divided into 3 segment TDWs, where the segment TDW 1 covers the first 4 slots of the target uplink channel, the segment TDW 2 covers the middle 4 slots of the target uplink channel, and the segment TDW 3 covers the last 4 slots of the target uplink channel. For the 1^{st} segment TDW (namely, segment TDW 1), in a case that the terminal device needs to send the target uplink channel through segment TDW 1, the terminal device may perform time domain synchronization and/or frequency domain synchronization before transmitting PUSCH 1, and after performing the time domain synchronization and/or the frequency domain synchronization, send through uplink channels (namely, PUSCH 1, PUSCH 2 and PUSCH 3) corresponding to segment TDW 1. In addition, before sending through the target uplink channel in the segment TDW 2 and the segment TDW 3, the terminal device also needs to perform time domain synchronization and/or frequency domain synchronization.

Optionally, that the terminal device performs time domain synchronization and/or frequency domain synchronization includes: the terminal device performs time domain synchronization and/or frequency domain synchronization based on at least one of a position, a public timing parameter, or serving satellite ephemeris information of the terminal device.

Optionally, that the terminal device performs time domain synchronization and/or frequency domain synchronization includes: the terminal device determines a T_{TA} value according to Formular (1).

In addition, the network device may determine, based on the first segment length, one or more segment TDWs corresponding through the target uplink channel. In this way, the network device may determine that, before sending through the target uplink channel based on each of the at least one segment TDW, the terminal device performs time domain synchronization and/or frequency domain synchronization for the segment TDW.

That is, the network device may also determine, based on the first segment length, the segment TDW corresponding through the target uplink channel, and after receiving the target uplink channel, may obtain, based on the determined segment TDW, an occasion on which the terminal device performs time domain synchronization and/or frequency domain synchronization, so as to perform corresponding channel estimation based on an occasion on which the terminal device performs uplink synchronization.

It can be evident from the uplink transmission method provided in this embodiment of this application, the terminal device may determine, based on the first segment length, the segment TDW corresponding through the target uplink channel, and perform time domain synchronization and/or frequency domain synchronization for the segment TDW. This ensures synchronization between the terminal device and the network device during transmission of the target uplink channel, and avoids a low channel estimation gain caused by frequent time domain synchronization and/or frequency domain synchronization by the terminal device.

A relationship between the segment TDW and the target uplink channel is described in detail below.

In some embodiments, a transmission duration of the target uplink channel corresponds to at least one segment TDW, and a start position of a 1^{st} segment TDW in the at least one segment TDW is a start position of a 1^{st} uplink channel in the N uplink channels.

That is, the terminal device or the network device may divide the transmission duration of the target uplink channel, starting from the start position of the 1^{st} uplink channel in the target uplink channel to obtain at least one segment TDW corresponding through the target uplink channel. It should be understood that the start position of the 1^{st} segment TDW in the at least one segment TDW is the same as a start position of the target uplink channel.

Optionally, the start position of the 1^{st} uplink channel is a 1^{st} symbol of the 1^{st} uplink channel.

It should be noted that the symbol may be a smallest time unit in time domain, and the symbol may be an orthogonal frequency division multiplexing (OFDM) symbol, or another time domain symbol, which is not limited in embodiments of this application.

That is, the 1^{st} segment TDW in the at least one segment TDW in embodiments of this application may start from the 1^{st} symbol of the 1^{st} uplink channel in the target uplink channel.

Optionally, the 1^{st} uplink channel is the 1^{st} uplink channel of the N uplink channels determined according to a time domain resource allocation indication; or the 1^{st} uplink channel is a 1^{st} valid uplink channel of the N uplink channels.

It should be understood that, in some embodiments, the 1^{st} uplink channel may be a 1^{st} configured uplink channel in the N uplink channels. That is, a start position of the at least one segment TDW may be a start position (or a 1^{st} symbol) of the 1^{st} configured uplink channel in the N uplink channels.

In some other embodiments, there is an invalid uplink channel in the N uplink channels in the time domain resource allocation indication. For example, the network device may indicate to the terminal device that a specific PUSCH is an invalid channel. In this case, the 1^{st} uplink channel may be the 1^{st} valid uplink channel in the N uplink channels determined by the time domain resource allocation indication. That is, a start position of the at least one segment TDW may be a start position (or a 1^{st} symbol) of the 1^{st} valid uplink channel in the N uplink channels.

Optionally, an end position of a last segment TDW in the at least one segment TDW is an end position of an N^{th} uplink channel in the N uplink channels. That is, the end position of the last segment TDW in the at least one segment TDW is the end position of the last uplink channel in the N uplink channels.

Optionally, the end position of the N^{th} uplink channel may be a last symbol of the N^{th} uplink channel.

In some embodiments, in a case that the transmission duration of the target uplink channel corresponds to at least two segment TDWs, a start position of a (K+1)^{th} segment TDW in the at least two segment TDWs is an end position of a K^{th} segment TDW in the at least two segment TDWs, and K is a positive integer.

It can be understood that all segment TDWs in the at least two segment TDWs may be connected end to end, and an end position of one segment TDW is a start position of the next segment TDW. That is, in this embodiment, regardless of whether the end position of the segment TDW is a channel gap (GAP) or is an end position of a specific uplink channel in the N uplink channels, the start position of the next segment TDW is the end position of the segment TDW.

For example, as shown in FIG. 5, it is assumed that the first segment length is 4 slots, and it may be determined, based on the first segment length, that the target uplink channel includes 3 segment TDWs. If an end position of the segment TDW 1 is a last symbol of GAP 1, a start position of the segment TDW 2 may be the last symbol of GAP 1. In addition, if an end position of the segment TDW 2 is a last symbol of PUSCH 7, a start position of the segment TDW 3 may be the last symbol of PUSCH 7.

In some other embodiments, in a case that the transmission duration of the target uplink channel corresponds to at least two segment TDWs, a start position of a (K+1)^{th} segment TDW in the at least two segment TDWs is a start position of an M^{th} uplink channel in the N uplink channels, where K is a positive integer, and M is a positive integer.

It may be understood that, in the at least two segment TDWs in this embodiment of this application, a start position of each segment TDW other than the 1^{st} segment TDW may be a start position of a specific uplink channel in the N uplink channels. That is, in this embodiment, if there is a GAP between an end position of a segment TDW, namely, an (M−1)^{th} uplink channel, and an M^{th} uplink channel, a start position of the next segment TDW may not be an end position of the segment TDW, but a start position of the M^{th} uplink channel in the N uplink channels. The (M−1)^{th} uplink signal and the M^{th} uplink channel are two adjacent uplink channels in the N uplink channels.

For example, as shown in FIG. 6, it is assumed that the first segment length is 4 slots, the segment TDW 1 determined based on the first segment length may include a maximum of 3 PUSCHs. Therefore, an end position of the segment TDW 1 is a last symbol of PUSCH 3. When there is a GAP between PUSCH 3 and PUSCH 4, a start position of the segment TDW 2 may be a 1^{st} symbol of PUSCH 4.

In some other embodiments, in a case that the transmission duration of the target uplink channel corresponds to at least two segment TDWs, a start position of a (K+1)^{th} segment TDW in the at least two segment TDWs is a start position of a time unit in which an M^{th} uplink channel in the N uplink channels is located, where K is a positive integer, and M is a positive integer.

It should be understood that because a start position of an uplink channel may be a specific symbol in a time slot, in the at least two segment TDWs of this embodiment, a start position of each segment TDW other than the 1^{st} segment TDW may be a start position of a time unit in which a specific uplink channel in the N uplink channels is located.

In some embodiments, the start position of the 1^{st} segment TDW may be a start position of a time unit in which a 1^{st} uplink channel in the N uplink channels is located.

The time unit may be one time slot, a half of one time slot, a plurality of symbols, one subframe, or the like, which is not limited in embodiments of this application.

In one embodiment of this application, a transmission duration of the target uplink channel corresponds to at least one segment TDW, and each segmented DTW in the at least one segment TDW includes one or more actual TDWs; and a start position of a 1^{st} actual TDW in a first segment TDW is a start position of the first segment TDW, and if an event that destroys power consistency and phase continuity occurs, an end position of the 1^{st} actual TDW is a last symbol of an uplink channel corresponding to a time at which the event occurs; and/or if no event that destroys power consistency and phase continuity occurs, an end position of the 1^{st} actual TDW is an end position of the first segment TDW, where the first segment TDW is one of the at least one segment TDW.

It should be understood that in order to implement joint channel estimation, an actual TDW may be further introduced in embodiments of this application. It should be noted that the terminal device needs to maintain power consistency and phase consistency within each actual TDW, so that the network device can perform joint channel estimation based on each actual TDW to enhance uplink coverage of the terminal device.

In this embodiment of this application, each segment TDW may include one or more actual TDWs. If no event that destroys power consistency and phase continuity occurs in a specific segment TDW, the segment TDW may include only one actual TDW. A start position of the actual TDW is a start position of a current segment TDW, and an end position of the actual TDW is an end position of the current segment TDW.

In addition, if an event that destroys power consistency and phase continuity occurs in a specific segment TDW, the segment TDW is divided into a plurality of actual TDWs, or an actual TDW in the segment TDW ends prematurely.

Specifically, a start position of the 1^{st} actual TDW in each segment TDW may be the same as a start position of the current segment TDW. If an event that destroys power consistency and phase continuity occurs in the current segment TDW, an end position of the 1^{st} actual TDW is a last symbol of an uplink channel transmission being transmitted when the event occurs.

When an event that destroys power consistency and phase continuity occurs, if the terminal device has a capability to restart DMRS bundling, a new actual TDW (that is, the segment TDW includes a plurality of actual TDWs) is created after the event ends. If the terminal device has no capability to restart DMRS bundling, no new actual TDW is created until the segment TDW ends. That is, the segment TDW includes only one actual TDW, and the end position of the TDW is a last symbol of an uplink channel being transmitted when the event that destroys power consistency and phase continuity occurs.

In another embodiment of this application, a transmission duration of the target uplink channel corresponds at least one segment TDW. In a first segment TDW, if an event that destroys power consistency and phase continuity occurs, an end position of the first segment TDW is a last symbol of an uplink channel corresponding to a time at which the event occurs; and/or if no event that destroys power consistency and phase continuity occurs, an end position of the first segment TDW is determined based on the first segment length; where the first segment TDW is one of the at least one segment TDW.

Optionally, when an event that destroys power consistency and phase continuity occurs, the terminal device creates a new segment TDW after the event ends. Optionally, whether the terminal device creates a new segment TDW is determined based on a minimum time interval and/or a maximum time interval at which the terminal device is capable of performing time domain synchronization and/or frequency domain synchronization.

It should be noted that the at least one segment TDW in this embodiment of this application may be determined by the terminal device based on the first segment length and the target uplink channel. A start position of the 1^{st} segment TDW in the at least one segment TDW may be determined in the manner described in the foregoing embodiment, and a relationship between segment TDWs in the at least one segment TDW may also be determined in the manner described in the foregoing embodiment. Details are not described herein again. In addition, a length of a TDW other than the last segment TDW in the at least one segment TDW may be determined based on the first segment length. For example, a length of each TDW other than the last segment TDW in the at least one segment TDW may be the first segment length.

For example, as shown in FIG. 7, the target uplink channel may include 10 PUSCH retransmissions, and the target uplink channel corresponds to three segment TDWs: segment TDW 1, the segment TDW 2, and the segment TDW 3. If an event 1 that destroys power consistency and phase continuity occurs during transmission of PUSCH 2 in segment TDW 1, the 1^{st} actual TDW in the segment TDW 1 may end at a last symbol of PUSCH 2. If the current terminal device currently has a capability to restart DMRS bundling, the terminal device creates a new actual TDW after PUSCH 2 ends. A start position of the new actual TDW is a 1^{st} symbol of PUSCH 3. Before the segment TDW 1 ends, no event that destroys power consistency and phase continuity occurs. Therefore, an end position of the new actual TDW is an end position of segment TDW 1, namely, a last symbol of PUSCH 4.

In addition, if an event 2 that destroys power consistency and phase continuity occurs during transmission of PUSCH 7 in the segment TDW 2, a 1^{st} actual TDW in the segment TDW 2 may end at a last symbol of PUSCH 7. The terminal device may create a new actual TDW after PUSCH 7 ends. A start position of the new actual TDW is a 1^{st} symbol of PUSCH 8. Before the segment TDW 2 ends, no event that destroys power consistency and phase continuity occurs. Therefore, an end position of the new actual TDW is an end position of the segment TDW 2, namely, a last symbol of PUSCH 8.

In a transmission duration of PUSCHs shown in FIG. 7, same filling patterns represent same power consistency and phase continuity.

Optionally, the event that destroys power consistency and phase continuity includes at least one of the following: in a TDD spectrum, a downlink slot or downlink reception or downlink monitoring being determined based on a semi-static downlink/uplink configuration pattern; for a normal CP, a gap between two consecutive uplink channel transmissions being greater than 13 symbols; and for an extended CP, a gap between two consecutive uplink channel transmissions being greater than 11 symbols; in a case that a gap between two consecutive uplink channel transmissions being not greater than 13 symbols, the terminal device being scheduled for an uplink transmission other than transmission of the target uplink channel in the gap; based on a collision rule defined by a protocol, transmissions of one or more uplink channels in the target uplink channel being discarded or canceled; in a case that the target uplink channel is a PUSCH, two consecutive uplink channel transmissions being associated with different uplink beams; in a case that the target uplink channel is a PUCCH, two consecutive uplink channel transmissions being associated with different uplink beams or different power control parameters; TA adjustment being performed based on a timing advance command TAC received by the terminal device; frequency hopping processing in frequency domain being performed; or in a case that the terminal device is a half-duplex FDD compact terminal and the target uplink channel is a PUSCH, an uplink channel transmission being discarded or canceled based on a discard rule defined by a protocol, or a symbol overlapping with downlink reception or downlink monitoring existing between two consecutive uplink channel transmissions.

It can be learned that in the transmission method provided in this embodiment of this application, before sending through the target uplink channel in each segment TDW, the terminal device may perform time domain synchronization and/or frequency domain synchronization for the segment TDW. This ensures synchronization between the terminal device and the network device during transmission of the target uplink channel. In addition, the terminal device maintains power consistency and phase continuity within an actual TDW in each segment TDW, so that the network device may perform DMRS bundling-based joint channel estimation based on the actual TDW in each segment TDW, thereby improving a channel estimation gain of the terminal device.

In one embodiment of this application, a transmission duration of the target uplink channel corresponds to at least one nominal TDW, and each of the at least one nominal TDW includes one or more segment TDWs; where a start position of a 1^{st} segment TDW in a first nominal TDW is a start position of the first nominal TDW, and the first nominal TDW is one of the at least one nominal TDW.

It should be understood that in order to be compatible with a coverage enhancement technology of DMRS bundling-based joint channel estimation in the related art, both a nominal TDW and an actual TDW may be further introduced in embodiments of this application, to be combined with the segment TDW in the foregoing embodiment.

Herein, the transmission duration of the target uplink channel may correspond to at least one nominal TDW, a length of a nominal TDW other than a last nominal TDW in the at least one nominal TDW may be configured by the network device or predefined, or calculated according to a predefined rule, which is not limited in embodiments of this application.

Optionally, the length of the nominal TDW is determined based on the first segment length. For example, the length of the nominal TDW is less than or equal to the first segment length.

Optionally, the length of the nominal TDW is determined based on the first segment length and a maximum duration for which the terminal device is capable of maintaining power consistency and phase continuity. For example, the length of the nominal TDW is less than or equal to a smaller value of the first segment length and the maximum duration.

In this embodiment of this application, the terminal device may determine a segment TDW based on the first segment length and the nominal TDW. Specifically, each nominal TDW may include one or more segment TDWs. A start position of a 1^{st} segment TDW in the first nominal TDW is a start position of the current nominal TDW. In addition, an end position of a last segment TDW in each nominal TDW may be an end position of the current nominal TDW.

In some embodiments, a length of a segment TDW other than the 1^{st} segment TDW and a last segment TDW in the first nominal TDW is determined based on the first segment length.

Optionally, a length of the 1^{st} segment TDW in the first nominal TDW is determined based on the first segment length; or a length of the 1^{st} segment TDW in the first nominal TDW is determined based on a length of a last segment TDW in a nominal TDW previous to the first nominal TDW and the first segment length.

It should be understood that when the length of the nominal TDW configured by the network device or predefined is equal to the first segment length, each nominal TDW includes only one segment TDW, and a length of a segment TDW (nominal TDW) other than a last segment TDW (nominal TDW) in at least one segment TDW (nominal TDW) corresponding through the target uplink channel is determined based on the first segment length, for example, may be the first segment length.

In addition, when the length of the nominal TDW configured by the network device or predefined is greater than the first segment length, each nominal TDW may include a plurality of segment TDWs. A length of a segment TDW other than a last segment TDW in a plurality of segment TDWs included in each nominal TDW may be determined based on the first segment length, for example, may be the first segment length.

For example, as shown in FIG. 8, the target uplink channel include 10 PUSCH retransmissions, and each PUSCH occupies one slot. It is assumed that the length of the nominal TDW configured by the network device is 4 slots and the first segment length is 3 slots. Based on the length of the nominal TDW, 10 PUSCH retransmissions for the target uplink channel may correspond to 3 nominal TDWs, where the length of each of the nominal TDW 1 and the nominal TDW 2 is 4 slots, and a length of the nominal TDW 3 is 2 slots.

In addition, based on the first segment length, the nominal TDW 1 and the nominal TDW 2 each may include two segment TDWs, where a length of a 1^{st} segment TDW (namely, the segment TDW 1) in the nominal TDW 1 is 3 slots, and a length of a 2^{nd} segment TDW (namely, the segment TDW 2) in the nominal TDW 1 is 1 slot. In addition, a length of a 1^{st} segment TDW (namely, the segment TDW 3) in the nominal TDW 2 is 3 slots, and a length of a 2^{nd} segment TDW (namely, the segment TDW 4) in the nominal TDW 2 is 1 slot. The nominal TDW 3 is a last nominal TDW, and its length is 2 slots. The nominal TDW 3 includes only one segment TDW (namely, the segment TDW 5).

Alternatively, when the length of the nominal TDW configured by the network device or predefined is greater than the first segment length, a length of a 1^{st} segment TDW in each nominal TDW may be determined based on a length of a last segment TDW in a nominal TDW previous to the current nominal TDW and the first segment length. In this scenario, if FIG. 8 is still used as an example, the segment TDW 1 corresponds to PUSCH 1, PUSCH 2, and PUSCH 3; the segment TDW 2 corresponds to PUSCH 4, PUSCH 5 and PUSCH 6; the segment TDW 3 corresponds to PUSCH 7, PUSCH 8, and PUSCH 9; segment TDW 4 corresponds to PUSCH 10.

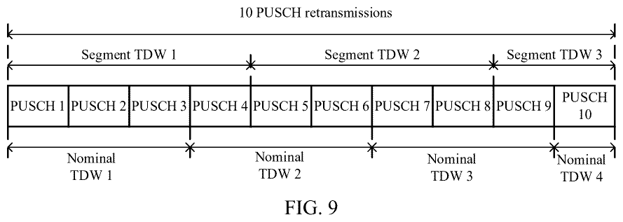

When the length of the nominal TDW configured by the network device or predefined is less than the first segment length, some segment TDWs in the at least one segment TDW corresponding through the target uplink channel may be interrupted by a nominal TDW. For example, as shown in FIG. 9, the length of the nominal TDW is a transmission duration of 3 PUSCHs, and the first segment length is a transmission duration of 4 PUSCHs. 10 PUSCH retransmissions of the target uplink channel may correspond to 3 segment TDWs. The segment TDW 1 is interrupted by the nominal TDW 1, the segment TDW 2 is interrupted by the nominal TDW 2, and the segment TDW 3 is interrupted by the nominal TDW 3.

Alternatively, in this scenario, a length of a 1^{st} segment TDW in each nominal TDW may be determined based on a length of a last segment TDW in a nominal TDW previous to the current nominal TDW and the first segment length.

Optionally, a length of a segment TDW other than the 1^{st} segment TDW and a last segment TDW in each nominal TDW is determined based on the first segment length. A length of the 1^{st} segment TDW in each nominal TDW may be the first segment length minus a length of a last segment TDW in a previous nominal TDW.

As shown in FIG. 9, the segment TDW 2 includes a transmission duration of PUSCH 5 and PUSCH 6 in the nominal TDW 2 and a transmission duration of PUSCH 7 and PUSCH 8 in the nominal TDW 3, that is, a length of a 1^{st} segment TDW in the nominal TDW 3 is the first segment length minus a transmission duration of 2 PUSCHs included in the nominal TDW 2.

Optionally, in this embodiment of this application, the segment TDW is determined based on the first segment length, and the terminal device performs time domain synchronization and/or frequency domain synchronization for each segment TDW. In other words, the segment TDW and the nominal TDW are determined independently, and regardless of whether the length of the nominal TDW is greater than or less than the first segment length, the terminal device needs to perform time domain synchronization and/or frequency domain synchronization based on the segment TDW determined based on the first segment length.

Optionally, in this embodiment of this application, the terminal device performs time domain synchronization and/or frequency domain synchronization for each segment TDW. Further, time domain synchronization and/or frequency domain synchronization may be performed for each nominal TDW. That is, before transmitting the target uplink channel through each nominal TDW, the terminal device performs time domain synchronization and/or frequency domain synchronization for each nominal TDW.

In this embodiment of this application, the transmission duration of the target uplink channel corresponds to at least one nominal TDW, and each of the at least one nominal TDW may include one or more actual TDWs; and a start position of a 1^{st} actual TDW in a first nominal TDW is a start position of the first nominal TDW, and if an event that destroys power consistency and phase continuity occurs, an end position of the 1^{st} actual TDW is a last symbol of an uplink channel corresponding to a time at which the event occurs; and/or if no event that destroys power consistency and phase continuity occurs, an end position of the 1^{st} actual TDW is an end position of the first nominal TDW; where the first nominal TDW is one of the at least one nominal TDW.

It should be understood that each of the at least one nominal TDW may include one or more actual TDWs. The terminal device needs to maintain power consistency and phase consistency within each actual TDW, so that the network device can perform joint channel estimation based on each actual TDW to enhance uplink coverage of the terminal device.

Specifically, if no event that destroys power consistency and phase continuity occurs in a nominal TDW, the nominal TDW includes only one actual TDW. A start position of the actual TDW is a start position of a current nominal TDW, and an end position of the actual TDW is an end position of the current nominal TDW.

If an event that destroys power consistency and phase continuity occurs in a specific nominal TDW, the nominal TDW is divided into a plurality of actual TDWs, or an actual TDW in the nominal TDW ends prematurely.

Specifically, a start position of a 1^{st} actual TDW in a nominal TDW may be the same as a start position of the current nominal TDW. If an event that destroys power consistency and phase continuity occurs in the current nominal TDW, an end position of the 1^{st} actual TDW is a last symbol of an uplink channel transmission being transmitted when the event occurs.

When an event that destroys power consistency and phase continuity occurs, if the terminal device has a capability to restart DMRS bundling, a new actual TDW is created after the event ends. If the terminal device has no capability to restart DMRS bundling, no new actual TDW is created until the nominal TDW ends.

In some embodiments, the event that destroys power consistency and phase continuity includes at least one of the following: in a TDD spectrum, a downlink slot or downlink reception or downlink monitoring being determined based on a semi-static downlink/uplink configuration pattern; for a normal CP, a gap between two consecutive uplink channel transmissions being greater than 13 symbols; and for an extended CP, a gap between two consecutive uplink channel transmissions being greater than 11 symbols; in a case that a gap between two consecutive uplink channel transmissions being not greater than 13 symbols, the terminal device being scheduled for an uplink transmission other than transmission of the target uplink channel in the gap; based on a collision rule defined by a protocol, transmissions of one or more uplink channels in the target uplink channel being discarded or canceled; in a case that the target uplink channel is a PUSCH, two consecutive uplink channel transmissions being associated with different uplink beams; in a case that the target uplink channel is a PUCCH, two consecutive uplink channel transmissions being associated with different uplink beams or different power control parameters; TA adjustment being performed based on a timing advance command TAC received by the terminal device; frequency hopping processing in frequency domain being performed; or in a case that the terminal device is a half-duplex FDD compact terminal and the target uplink channel is a PUSCH, an uplink channel transmission being discarded or canceled based on a discard rule defined by a protocol, or a symbol overlapping with downlink reception or downlink monitoring existing between two consecutive uplink channel transmissions.

In some other embodiments, the event that destroys power consistency and phase continuity may further include: that transmissions through an uplink channel in the first nominal TDW is interrupted by any one of the segment TDWs. That is, during transmission of the target uplink channel, after transmissions through an uplink channel in a nominal TDW is interrupted by a segment TDW, an actual TDW in the current nominal TDW ends.

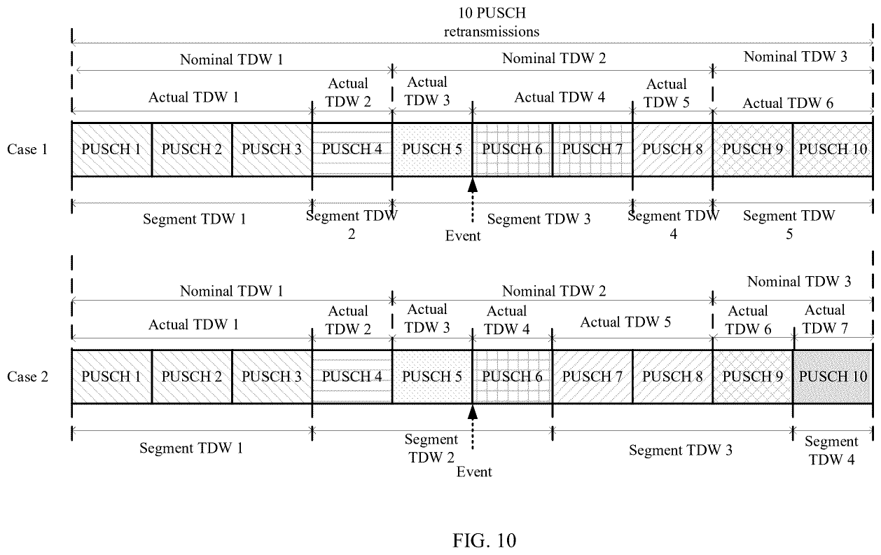

For example, as shown by Case 1 in FIG. 10, the nominal TDW 1 includes two segment TDWs: the segment TDW 1 and the segment TDW 2. When a last symbol of PUSCH 3 ends in segment TDW 1, a 1^{st} actual TDW (actual TDW 1) in the nominal TDW 1 also ends at the last symbol of PUSCH 3. Further, assuming that the terminal device has a capability to restart DMRS bundling, the terminal device creates a new actual TDW (actual TDW 2) after PUSCH 3 ends, and an end position of the actual TDW 2 is an end position of nominal TDW 1.

In addition, the nominal TDW 2 also includes two segment TDWs: the segment TDW 3 and segment TDW 4. If an event that destroys power consistency and phase continuity occurs during transmission of PUSCH 5, an end position of a 1^{st} actual TDW (actual TDW 3) in the nominal TDW 2 is a last symbol of PUSCH 5 being transmission when the event occurs. The terminal device may create a 2^{nd} actual TDW (namely, actual TDW 4) of nominal TDW 2 after PUSCH 5 ends. Further, PUSCH 7 transmitted in the nominal TDW 2 is interrupted by the segment TDW 3, and in this case, an end position of a 2^{nd} actual TDW (namely, actual TDW 4) in the nominal TDW 2 is a last symbol of PUSCH 7. Next, the terminal device may further create a 3rd actual TDW (namely, actual TDW 5) for the nominal TDW 2. If no event that destroys power consistency and phase continuity occurs before the nominal TDW 2 ends, an end position of actual TDW 5 is an end position of the nominal TDW 2.

Optionally, in Case 1, before sending a target PUSCH, the terminal device performs time domain synchronization and/or frequency domain synchronization for each segment TDW in the segment TDW 1, the segment TDW 2, the segment TDW 3, the segment TDW 4, and the segment TDW 5.

For example, from Case 2 in FIG. 10, the nominal TDW 1 also includes two segment TDWs: the segment TDW 1 and the segment TDW 2. When a last symbol of PUSCH 3 ends in segment TDW 1, a 1^{st} actual TDW (actual TDW 1) in the nominal TDW 1 also ends at the last symbol of PUSCH 3. Further, assuming that the terminal device has a capability to restart DMRS bundling, the terminal device creates a new actual TDW (actual TDW 2) after PUSCH 3 ends, and an end position of the actual TDW 2 is an end position of the nominal TDW 1.

In addition, the segment TDW 2 is interrupted by the nominal TDW 2. In the nominal TDW 2, if an event that destroys power consistency and phase continuity occurs during transmission of PUSCH 5, an end position of a 1^{st} actual TDW (actual TDW 3) in the nominal TDW 2 is a last symbol of PUSCH 5 being transmission when the event occurs. The terminal device may create a 2^{nd} actual TDW (namely, actual TDW 4) of the nominal TDW 2 after PUSCH 5 ends. Further, PUSCH 6 transmitted in the nominal TDW 2 is interrupted by the segment TDW 2, and in this case, an end position of a 2^{nd} actual TDW (namely, actual TDW 4) in the nominal TDW 2 is a last symbol of PUSCH 6. Next, the terminal device may further create a 3rd actual TDW (namely, actual TDW 5) for the nominal TDW 2 based on the segment TDW 3. If no event that destroys power consistency and phase continuity occurs before the nominal TDW 2 ends, an end position of actual TDW 5 is an end position of the nominal TDW 2.

In addition, in the nominal TDW 3, the PUSCH transmission is interrupted by the segment TDW 3, and therefore the nominal TDW 3 includes two actual TDWs (namely, the actual TDW 6 and the actual TDW 7).

Optionally, in Case 2, before sending a target PUSCH, the terminal device performs time domain synchronization and/or frequency domain synchronization for each of the segment TDW 1, the segment TDW 2, the segment TDW 3, and the segment TDW 4.

It should be noted that the terminal device maintains power consistency and phase continuity within each actual TDW. In the transmission durations of PUSCHs shown in Case 1 of FIG. 10 and Case 2 of FIG. 10, same filling patterns represent same power consistency and phase continuity.

Optionally, when transmissions through the target uplink channel are interrupted by a segment TDW, the terminal device needs to support restarting of DMRS bundling.

Optionally, when transmissions through the target uplink channel are interrupted by a segment TDW, whether the terminal device supports or does not support restarting of DMRS bundling.

It is evident from the transmission method provided in this embodiment of this application, before sending through the target uplink channel in each segment TDW, the terminal device performs time domain synchronization and/or frequency domain synchronization for the segment TDW. This ensures synchronization between the terminal device and the network device during transmission of the target uplink channel. In addition, the terminal device maintains power consistency and phase continuity within an actual TDW in each segment TDW, so that the network device can perform DMRS bundling-based joint channel estimation based on the actual TDW in each segment TDW, thereby improving a channel estimation gain of the terminal device.

In one embodiment of this application, the terminal device may prohibit time domain synchronization and/or frequency domain synchronization that is based on at least one of a position, a public timing parameter, or serving satellite ephemeris information of the terminal device within each segment TDW; and/or the terminal device prohibits TA adjustment that is based on a received timing advance command (TAC) within each segment TDW.

It may be understood that, during transmission of the target uplink channel, the terminal device may perform time domain synchronization and/or frequency domain synchronization for each segment TDW. However, in this embodiment of this application, for each segment TDW obtained after time domain synchronization and/or frequency domain synchronization, the terminal device may prohibit time domain/frequency domain adjustment within the segment TDW. In this way, the network device may perform joint channel estimation by using information received in each segment TDW, to ensure a gain of DMRS bundling-based joint channel estimation.

Optionally, that the terminal device prohibits time domain/frequency domain adjustment within each segment TDW may include: the terminal device prohibits time domain synchronization and/or frequency domain synchronization that is based on at least one of a position, a public timing parameter, or serving satellite ephemeris information of the terminal device within each segment TDW; and/or the terminal device prohibits TA adjustment performed by the terminal device based on a received timing advance command within each segment TDW.

Optionally, the public timing parameter and the serving satellite ephemeris information may be configured by a higher layer, for example, configured by a network device through a system message.

Correspondingly, after determining a plurality of segment TDWs of the target uplink channel based on the first segment length, the network device may determine that the terminal device does not perform time domain synchronization and/or frequency domain synchronization that are/is based on at least one of a position, a public timing parameter, or serving satellite ephemeris information of the terminal device within each segment TDW; and/or determine that the terminal device does not perform TA adjustment based on a received timing advance command TAC within each segment TDW.

That is, the network device may also determine a plurality of segment TDWs based on the first segment length, and determine, based on the plurality of segment TDWs, an accurate occasion on which the terminal device performs time domain synchronization and/or frequency domain synchronization, and then the network device may perform DMRS bundling-based joint channel estimation based on information received through the plurality of segment TDWs.

It can be evident from the uplink transmission method provided in this embodiment of this application, the network device and the terminal device determine, based on the first segment length, an occasion on which the terminal device performs time domain synchronization and/or frequency domain synchronization, to implement a coverage enhancement technology of DMRS bundling-based joint channel estimation in an NTN system, thereby enhancing coverage of the terminal device.

It should be understood that in some embodiments, the terminal device may prohibit, within each segment TDW, execution of a TAC sent by the network device. For example, when the terminal device receives a TAC and determines that TA adjustment corresponding to the TAC should be applied starting from transmission of an uplink channel transmission within a specific segment TDW, the terminal device cannot perform the corresponding TA adjustment within the segment TDW. In some other embodiments, when receiving a TAC indicating TA adjustment within a segment TDW, the terminal device may respond to the TAC. For example, when the terminal device receives a TAC and determines that TA adjustment corresponding to the TAC should be applied starting from transmission of an uplink channel within a specific segment TDW, the terminal device may perform the corresponding TA adjustment.

In a possible implementation, when the terminal device is instructed to perform TA adjustment based on the received TAC within a first segment TDW, the terminal device may determine to execute the TAC within the first segment TDW; where the first segment TDW is any one of the plurality of segment TDWs.

That is, during transmission of the target uplink channel through a plurality of segment TDWs, when the terminal device receives a TAC and the TAC requires the terminal device to adjust TA within a specific segment time domain window, the terminal device may execute, in the segment TDW, the TAC sent by the network device, to perform TA adjustment.

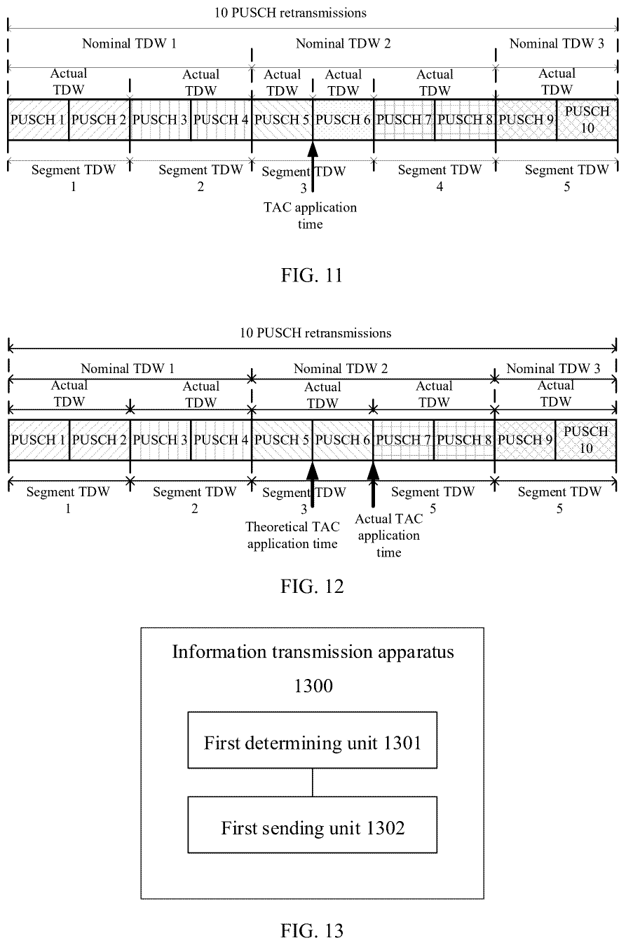

For example, as shown FIG. 11, if the terminal device receives a TAC, and according to a TAC application time, the TAC indicates that TA adjustment should be performed starting from a specific PUSCH in the segment TDW 3, the terminal device may execute the TAC at a 1^{st} symbol of the PUSCH in the segment TDW 3, for example, perform TA adjustment at a 1^{st} symbol of PUSCH 6 shown in FIG. 11, so that PUSCH 5 and PUSCH 6 may no longer maintain power consistency and/or phase continuity.

It can be learned that in the uplink transmission method in this embodiment of this application, the terminal device can flexibly perform TA adjustment as indicated by the network device.

In another possible implementation, when the terminal device is instructed to perform TA adjustment based on the received TAC within a first segment TDW, the terminal device determines to perform TA adjustment based on the TAC before sending through the target uplink channel in a second segment TDW; where the first segment TDW is one of the plurality of segment TDWs, and the second segment TDW is located after the first segment TDW and is adjacent to the first segment TDW.

That is, during sending of the target uplink channel through the foregoing plurality of segment TDWs, when the terminal device receives a TA command sent by the network device and is required to perform TA adjustment within a specific segment TDW, the terminal device may execute the TAC starting from a next segment TDW following the current segment TDW.

For example, as shown in FIG. 12, when the terminal device receives a TAC instruction and according to a TAC application time, the terminal device should perform TA adjustment within the segment TDW 3, the terminal device may perform TA adjustment after the segment TDW 3 ends and before transmitting the target uplink channel through segment TDW 4. It can be learned from FIG. 12 that an actual execution time of the TAC is before transmission of PUSCH 7.

Correspondingly, the network device sends a timing advance command TAC to the terminal device, and if the terminal device should perform TA adjustment based on the TAC instruction within a first segment TDW, the network device determines that the terminal device performs TA adjustment based on the TAC before sending through the target uplink channel in a second segment TDW; where the first segment TDW is one of the plurality of segment TDWs, and the second segment TDW is located after the first segment TDW and is adjacent to the first segment TDW.

That is, when the network device sends, to the terminal device, a TAC instructing the terminal device to perform TA adjustment within a specific segment TDW, the network device and the terminal device agree not to execute the TAC in the segment TDW indicated by the TAC, but to execute the TAC in a next TDW following the segment TDW indicated by the TAC. This can keep the TA unchanged in the segment TDW, and responding to the TAC is performed while power consistency and phase continuity are maintained. Flexibility of information processing by the terminal device is improved.

In some embodiments, before step 410, the terminal device may further perform the following step; sending, by the terminal device, capability information to the network device, where the capability information includes first capability information and/or second capability information; where the first capability information is used to indicate a minimum time interval at which the terminal device is capable of performing time domain synchronization and/or frequency domain synchronization and/or a maximum time interval at which the terminal device is capable of performing time domain synchronization and/or frequency domain synchronization; and the second capability information is used to indicate a maximum duration for which the terminal device is capable of maintaining power consistency and phase continuity.

Optionally, the minimum time interval at which the terminal device is capable of performing time domain synchronization and/or frequency domain synchronization includes: a minimum time interval at which the terminal device is capable of performing time domain synchronization and/or frequency domain synchronization based on at least one of a position, a public timing parameter, or serving satellite ephemeris information of the terminal device.

Optionally, the maximum time interval at which the terminal device is capable of performing time domain synchronization and/or frequency domain synchronization includes: a maximum time interval at which the terminal device is capable of performing time domain synchronization and/or frequency domain synchronization based on at least one of a position, a public timing parameter, or serving satellite ephemeris information of the terminal device.

It should be noted that the first capability information may explicitly or implicitly indicate a minimum time interval at which the terminal device is capable of performing time domain synchronization and/or frequency domain synchronization; and/or a maximum time interval at which the terminal device is capable of performing time domain synchronization and/or frequency domain synchronization, where the second capability information may explicitly or implicitly indicate a maximum duration for which the terminal device is capable of maintaining power consistency and phase continuity. A manner of indication is not limited in embodiments of this application.

Optionally, the first segment length may be determined based on the first capability information and/or the second capability information. For example, the first segment length is calculated by the terminal device based on the first capability information and/or the second capability information, or the first segment length is configured by the network device for the terminal device based on the first capability information and/or the second capability information, which is not limited in embodiments of this application.

In the uplink transmission method provided in this embodiment of this application, the terminal device and/or the network device may determine the first segment length for division of segment TDWs based on an actual capability of the terminal device. In this way, the segment TDW determined based on the first segment length can adapt to the actual capability of the terminal device, thereby ensuring synchronization between the terminal device and the network device all the time during transmission of the target uplink channel, and avoiding a low channel estimation gain caused frequent adjustment of time domain synchronization and/or frequency domain synchronization by the terminal device.

The foregoing describes in detail the preferred implementations of this application with reference to the accompanying drawings. However, this application is not limited to specific details in the foregoing implementation. Within a technical concept scope of this application, a plurality of simple variations of the technical solutions of this application may be performed, and these simple variations are all within the protection scope of this application. For example, the specific technical features described in the foregoing specific implementations may be combined in any suitable manner without contradiction. To avoid unnecessary repetition, various possible combination manners are not described otherwise in this application. For another example, any combination may also be performed between different implementations of this application, provided that the combination is not contrary to the idea of this application, the combination shall also be considered as the content disclosed in this application. For another example, various embodiments and/or technical features in the various embodiments described in this application may be arbitrarily combined with the prior art under the premise of no conflict, and technical solutions obtained after the combination shall also fall within the protection scope of this application.

It should be further understood that, in method embodiments of this application, sequence numbers of the foregoing processes do not mean execution sequences. The execution sequences of the processes should be determined according to functions and internal logic of the processes, and should not be construed as any limitation on the implementation processes of embodiments of this application. In addition, in embodiments of this application, the terms “downlink”, “uplink”, and “sidelink” are used to indicate a transmission direction of a signal or data, where “downlink” is used to indicate that a transmission direction of a signal or data is a first direction from a station to user equipment in a cell, “uplink” is used to indicate that a transmission direction of a signal or data is a second direction from user equipment in a cell to a station, and “sidelink” is used to indicate that a transmission direction of a signal or data is a third direction from user equipment 1 to user equipment 2. For example, “downlink signal” indicates that a transmission direction of the signal is the first direction. In addition, in embodiments of this application, the term “and/or” is merely used to describe an association relationship between associated objects, and represents that there may be three relationships. Specifically, A and/or B may represent three cases: only A exists, both A and B exist, and only B exists. In addition, the character “/” in the specification generally indicates an “or” relationship between the associated objects.

FIG. 13 is a schematic diagram 1 of a structural composition of an uplink transmission apparatus according to an embodiment of this application. The uplink transmission apparatus is applied to a terminal device, and as shown in FIG. 13, includes: a first determining unit 1301, configured to determine, based on a first segment length, a segment time domain window TDW corresponding to a target uplink channel, where the target uplink channel includes N uplink channels, the segment TDW is associated with a time interval at which the terminal device performs time domain synchronization and/or frequency domain synchronization, and N is a positive integer; and a first sending unit 1302, configured to send through the target uplink channel based on the segment TDW.

Optionally, a transmission duration of the target uplink channel corresponds to at least one segment TDW, and the first sending unit 1302 is further configured to: before sending through the target uplink channel based on each of the at least one segment TDW, perform time domain synchronization and/or frequency domain synchronization for the segment TDW.

Optionally, a transmission duration of the target uplink channel corresponds to at least one segment TDW, and a start position of a 1^{st} segment TDW in the at least one segment TDW is a start position of a 1^{st} uplink channel in the N uplink channels.

Optionally, the start position of the 1^{st} uplink channel is a 1^{st} symbol of the 1^{st} uplink channel; where the 1^{st} uplink channel is the 1^{st} uplink channel of the N uplink channels determined according to a time domain resource allocation indication; or the 1^{st} uplink channel is a 1^{st} valid uplink channel of the N uplink channels.

Optionally, a transmission duration of the target uplink channel corresponds to at least two segment TDWs, a start position of a (K+1)^{th} segment TDW in the at least two segment TDWs is an end position of a K^{th} segment TDW in the at least two segment TDWs, and K is a positive integer.

Optionally, a transmission duration of the target uplink channel corresponds to at least two segment TDWs, and a start position of a (K+1)^{th} segment TDW in the at least two segment TDWs is a start position of an M^{th} uplink channel in the N uplink channels; or a start position of a (K+1)^{th} segment TDW in the at least two segment TDWs is a start position of a time unit in which an M^{th} uplink channel in the N uplink channels is located, K is a positive integer, and M is a positive integer.

Optionally, a transmission duration of the target uplink channel corresponds to at least one segment TDW, and each segmented DTW in the at least one segment TDW includes one or more actual TDWs; and a start position of a 1^{st} actual TDW in a first segment TDW is a start position of the first segment TDW, and if an event that destroys power consistency and phase continuity occurs, an end position of the 1^{st} actual TDW is a last symbol of an uplink channel corresponding to a time at which the event occurs; and/or if no event that destroys power consistency and phase continuity occurs, an end position of the 1^{st} actual TDW is an end position of the first segment TDW; where the first segment TDW is one of the at least one segment TDW.

Optionally, a transmission duration of the target uplink channel corresponds to at least one nominal TDW, and each of the at least one nominal TDW includes one or more segment TDWs; where a start position of a 1^{st} segment TDW in a first nominal TDW is a start position of the first nominal TDW, and the first nominal TDW is one of the at least one nominal TDW.

Optionally, a length of a segment TDW other than the 1^{st} segment TDW and a last segment TDW in the first nominal TDW is determined based on the first segment length.

Optionally, a length of the 1^{st} segment TDW in the first nominal TDW is determined based on the first segment length; or a length of the 1^{st} segment TDW in the first nominal TDW is determined based on a length of a last segment TDW in a nominal TDW previous to the first nominal TDW and the first segment length.

Optionally, a transmission duration of the target uplink channel corresponds to at least one nominal TDW, and each of the at least one nominal TDW includes one or more actual TDWs; and a start position of a 1^{st} actual TDW in a first nominal TDW is a start position of the first nominal TDW, and if an event that destroys power consistency and phase continuity occurs, an end position of the 1^{st} actual TDW is a last symbol of an uplink channel corresponding to a time at which the event occurs; and/or if no event that destroys power consistency and phase continuity occurs, an end position of the 1^{st} actual TDW is an end position of the first nominal TDW; where the first nominal TDW is one of the at least one nominal TDW.

Optionally, the event that destroys power consistency and phase continuity includes: that transmissions through an uplink channel in the first nominal TDW is interrupted by any one of the segment TDWs.

Optionally, the terminal device prohibits, within each segment TDW, time domain synchronization and/or frequency domain synchronization that is based on at least one of a position, a public timing parameter, or serving satellite ephemeris information of the terminal device; and/or the terminal device prohibits TA adjustment that is based on a received timing advance command TAC within each segment TDW.

Optionally, when the terminal device is instructed to perform TA adjustment based on the received timing advance command TAC within the first segment TDW, the terminal device determines to perform TA adjustment based on the TAC before sending through the target uplink channel in a second segment TDW; where the first segment TDW is one of the plurality of segment TDWs, and the second segment TDW is located after the first segment TDW and is adjacent to the first segment TDW.

Optionally, the event that destroys power consistency and phase continuity includes at least one of the following: in a TDD spectrum, a downlink slot or downlink reception or downlink monitoring being determined based on a semi-static downlink/uplink configuration pattern; for a normal CP, a gap between two consecutive uplink channel transmissions being greater than 13 symbols; and for an extended CP, a gap between two consecutive uplink channel transmissions being greater than 11 symbols; in a case that a gap between two consecutive uplink channel transmissions being not greater than 13 symbols, the terminal device being scheduled for an uplink transmission other than transmission of the target uplink channel in the gap; based on a collision rule defined by a protocol, transmissions of one or more uplink channels in the target uplink channel being discarded or canceled; in a case that the target uplink channel is a PUSCH, two consecutive uplink channel transmissions being associated with different uplink beams; in a case that the target uplink channel is a PUCCH, two consecutive uplink channel transmissions being associated with different uplink beams or different power control parameters; TA adjustment being performed based on a timing advance command TAC received by the terminal device; frequency hopping processing in frequency domain being performed; or in a case that the terminal device is a half-duplex FDD compact terminal and the target uplink channel is a PUSCH, an uplink channel transmission being discarded or canceled based on a discard rule defined by a protocol, or a symbol overlapping with downlink reception or downlink monitoring existing between two consecutive uplink channel transmissions.

Optionally, the first segment length is predefined, or is determined according to a predefined rule, or is determined based on first configuration information sent by a network device, or is determined based on a segment length set configured by a network device.

Optionally, the first configuration information is carried in at least one of the following information: radio resource control RRC signaling, a system message, a medium access control control element MAC CE, or downlink control information DCI.

Optionally, in a case that the terminal device is in a connected state, the first configuration information is carried in RRC signaling specific to the terminal device; and/or in a case that the terminal device is in an idle state or an inactive state, the first configuration information is carried in a system message.

Optionally, the first sending unit 1302 is further configured to send capability information, where the capability information includes first capability information and/or second capability information; where the first capability information is used to indicate a minimum time interval at which the terminal device is capable of performing time domain synchronization and/or frequency domain synchronization and/or a maximum time interval at which the terminal device is capable of performing time domain synchronization and/or frequency domain synchronization; and the second capability information is used to indicate a maximum duration for which the terminal device is capable of maintaining power consistency and phase continuity.

Optionally, the target uplink channel includes at least one of the following: a physical uplink shared channel PUSCH, a physical uplink control channel PUCCH, or a physical random access channel PRACH.

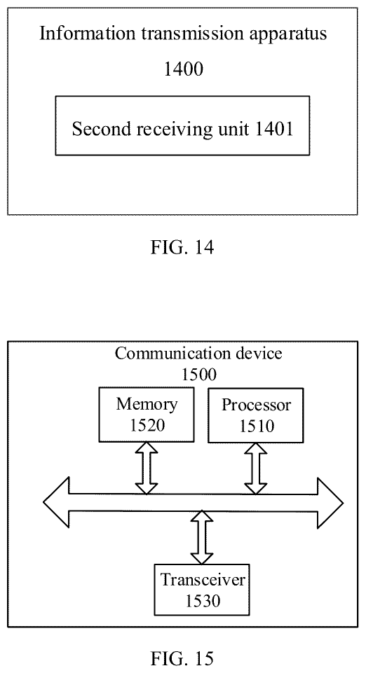

FIG. 14 is a schematic diagram 2 of a structural composition of an uplink transmission apparatus according to an embodiment of this application. The uplink transmission apparatus is applied to a network device, and as shown in FIG. 14, includes: a second receiving unit 1401, configured to receive transmissions through a target uplink channel, where the target uplink channel includes N uplink channels, the target uplink channel is transmitted in a plurality of segment time domain windows TDWs, the plurality of segment TDWs are determined based on a first segment length, the segment TDW is associated with a time interval at which a terminal device performs time domain synchronization and/or frequency domain synchronization, and N is a positive integer.

Optionally, the uplink transmission apparatus further includes a second determining unit, a transmission duration of the target uplink channel corresponds to at least one segment TDW, and the second determining unit is configured to determine that, before sending through the target uplink channel in each of the at least one segment TDW, the terminal device performs time domain synchronization and/or frequency domain synchronization for the segment TDW.

Optionally, a transmission duration of the target uplink channel corresponds to at least one segment TDW, and a start position of a 1^{st} segment TDW in the at least one segment TDW is a start position of a 1^{st} uplink channel in the N uplink channels.

Optionally, the start position of the 1^{st} uplink channel is a 1^{st} symbol of the 1^{st} uplink channel; where the 1^{st} uplink channel is the 1^{st} uplink channel of the N uplink channels determined according to a time domain resource allocation indication; or the 1^{st} uplink channel is a 1^{st} valid uplink channel of the N uplink channels.

Optionally, a transmission duration of the target uplink channel corresponds to at least two segment TDWs, a start position of a (K+1)^{th} segment TDW in the at least two segment TDWs is an end position of a K^{th} segment TDW in the at least two segment TDWs, and K is a positive integer.

Optionally, a transmission duration of the target uplink channel corresponds to at least two segment TDWs, and a start position of a (K+1)^{th} segment TDW in the at least two segment TDWs is a start position of an M^{th} uplink channel in the N uplink channels; or a start position of a (K+1)^{th} segment TDW in the at least two segment TDWs is a start position of a time unit in which an M^{th} uplink channel in the N uplink channels is located, K is a positive integer, and M is a positive integer.

Optionally, a transmission duration of the target uplink channel corresponds to at least one segment TDW, and each segmented DTW in the at least one segment TDW includes one or more actual TDWs; and a start position of a 1^{st} actual TDW in a first segment TDW is a start position of the first segment TDW, and if an event that destroys power consistency and phase continuity occurs, an end position of the 1^{st} actual TDW is a last symbol of an uplink channel corresponding to a time at which the event occurs; and/or if no event that destroys power consistency and phase continuity occurs, an end position of the 1^{st} actual TDW is an end position of the first segment TDW; where the first segment TDW is one of the at least one segment TDW.

Optionally, a transmission duration of the target uplink channel corresponds to at least one nominal TDW, and each of the at least one nominal TDW includes one or more segment TDWs; where a start position of a 1^{st} segment TDW in a first nominal TDW is a start position of the first nominal TDW, and the first nominal TDW is one of the at least one nominal TDW.

Optionally, a length of a segment TDW other than the 1^{st} segment TDW and a last segment TDW in the first nominal TDW is determined based on the first segment length.

Optionally, a length of the 1^{st} segment TDW in the first nominal TDW is determined based on the first segment length; or a length of the 1^{st} segment TDW in the first nominal TDW is determined based on a length of a last segment TDW in a nominal TDW previous to the first nominal TDW and the first segment length.

Optionally, a transmission duration of the target uplink channel corresponds to at least one nominal TDW, and each of the at least one nominal TDW includes one or more actual TDWs; and a start position of a 1^{st} actual TDW in a first nominal TDW is a start position of the first nominal TDW, and if an event that destroys power consistency and phase continuity occurs, an end position of the 1^{st} actual TDW is a last symbol of an uplink channel corresponding to a time at which the event occurs; and/or if no event that destroys power consistency and phase continuity occurs, an end position of the 1^{st} actual TDW is an end position of the first nominal TDW; where the first nominal TDW is one of the at least one nominal TDW.

Optionally, the event that destroys power consistency and phase continuity includes: that transmissions through an uplink channel in the first nominal TDW is interrupted by any one of the segment TDWs.

Optionally, the second determining unit is further configured to: determine that the terminal device does not perform time domain synchronization and/or frequency domain synchronization that are/is based on at least one of a position, a public timing parameter, or serving satellite ephemeris information of the terminal device within each segment TDW; and/or determine that the terminal device does not perform TA adjustment based on a received timing advance command TAC within each segment TDW.

Optionally, the uplink transmission apparatus further includes a second sending unit, configured to send a timing advance command TAC to the terminal device; and the second determining unit is further configured to: if the terminal device should perform TA adjustment based on the TAC instruction within a first segment TDW, determine, by the network device, that the terminal device performs TA adjustment based on the TAC before sending through the target uplink channel in a second segment TDW; where the first segment TDW is one of the plurality of segment TDWs, and the second segment TDW is located after the first segment TDW and is adjacent to the first segment TDW.

Optionally, the event that destroys power consistency and phase continuity includes at least one of the following: in a TDD spectrum, a downlink slot or downlink reception or downlink monitoring being determined based on a semi-static downlink/uplink configuration pattern; for a normal CP, a gap between two consecutive uplink channel transmissions being greater than 13 symbols; and for an extended CP, a gap between two consecutive uplink channel transmissions being greater than 11 symbols; in a case that a gap between two consecutive uplink channel transmissions being not greater than 13 symbols, the terminal device being scheduled for an uplink transmission other than transmission of the target uplink channel in the gap; based on a collision rule defined by a protocol, transmissions of one or more uplink channels in the target uplink channel being discarded or canceled; in a case that the target uplink channel is a PUSCH, two consecutive uplink channel transmissions being associated with different uplink beams; in a case that the target uplink channel is a PUCCH, two consecutive uplink channel transmissions being associated with different uplink beams or different power control parameters; TA adjustment being performed based on a timing advance command TAC received by the terminal device; frequency hopping processing in frequency domain being performed or; in a case that the terminal device is a half-duplex FDD compact terminal and the target uplink channel is a PUSCH, an uplink channel transmission being discarded or canceled based on a discard rule defined by a protocol, or a symbol overlapping with downlink reception or downlink monitoring existing between two consecutive uplink channel transmissions.

Optionally, the second sending unit is further configured to send first configuration information to the terminal device, where the first configuration information is used to determine the first segment length.

Optionally, the first configuration information is carried in at least one of the following information: radio resource control RRC signaling, a system message, a medium access control control element MAC CE, or downlink control information DCI.

Optionally, in a case that the terminal device is in a connected state, the first configuration information is carried in RRC signaling specific to the terminal device; and/or in a case that the terminal device is in an idle state or an inactive state, the first configuration information is carried in a system message.

Optionally, the second receiving unit 1401 is further configured to receive capability information sent by the terminal device, where the capability information includes first capability information and/or second capability information; where the first capability information is used to indicate a minimum time interval at which the terminal device is capable of performing time domain synchronization and/or frequency domain synchronization and/or a maximum time interval at which the terminal device is capable of performing time domain synchronization and/or frequency domain synchronization; and the second capability information is used to indicate a maximum duration for which the terminal device is capable of maintaining power consistency and phase continuity.

Optionally, the target uplink channel includes at least one of the following: a PUSCH, a PUCCH, or a PRACH.

A person skilled in the art should understand that related description of the foregoing uplink transmission apparatus in this embodiment of this application may be understood by referring to the related description of the uplink transmission method in embodiments of this application.

FIG. 15 is a schematic diagram of a structure of a communication device 1500 according to an embodiment of this application. The communication device may be a terminal device or a network device. The communication device 1500 shown in FIG. 15 includes a processor 1510, and the processor 1510 may invoke a computer program from a memory and run the computer program to implement the method in embodiments of this application.

Optionally, as shown in FIG. 15, the communication device 1500 may further include a memory 1520. The processor 1510 may invoke and run a computer program from the memory 1520 to implement the method in embodiments of this application. The memory 1520 may be a separate device independent of the processor 1510, or may be integrated in the processor 1510.

Optionally, as shown in FIG. 15, the communication device 1500 may further include a transceiver 1530. The processor 1510 may control the transceiver 1530 to communicate with another device, and specifically, may transmit information or data to the another device or receive information or data transmitted by the another device. The transceiver 1530 may include a transmitter and a receiver. The transceiver 1530 may further include an antenna, and a quantity of antennas may be one or more.

Optionally, the communication device 1500 may be specifically the network device according to embodiments of this application, and the communication device 1500 may implement a corresponding procedure implemented by the network device in various methods according to embodiments of this application. For brevity, details are not described herein again.

Optionally, the communication device 1500 may be specifically the mobile terminal/terminal device according to embodiments of this application, and the communication device 1500 may implement corresponding processes implemented by the mobile terminal/terminal device in various methods according to embodiments of this application. For brevity, details are not described herein again.

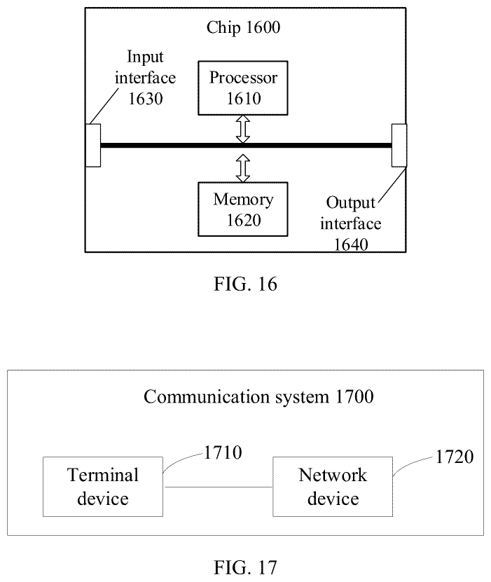

FIG. 16 is a schematic diagram of a structure of a chip according to an embodiment of this application. The chip 1600 shown in FIG. 16 includes a processor 1610, and the processor 1610 may invoke a computer program from a memory and run the computer program to implement a method in embodiments of this application.

Optionally, as shown in FIG. 16, the chip 1600 may further include a memory 1620. The processor 1610 may invoke and run a computer program from the memory 1620 to implement the method in embodiments of this application. The memory 1620 may be a separate device independent of the processor 1610, or may be integrated in the processor 1610.

Optionally, the chip 1600 may further include an input interface 1630. The processor 1610 may control the input interface 1630 to communicate with another device or chip, and specifically, may obtain information or data transmitted by the another device or chip.

Optionally, the chip 1600 may further include an output interface 1640. The processor 1610 may control the output interface 1640 to communicate with another device or chip, and specifically, may output information or data to the another device or chip.

Optionally, the chip may be applied to the network device in embodiments of this application, and the chip may implement a corresponding procedure implemented by the network device in various methods of the embodiments of this application. For brevity, details are not described herein again.

Optionally, the chip may be applied to a mobile terminal/terminal device in an embodiment of this application, and the chip may implement a corresponding procedure implemented by the mobile terminal/terminal device in various methods according to embodiments of this application. For brevity, details are not described herein again.

It should be noted that the chip mentioned in embodiments of this application may also be referred to as a system-level chip, a system chip, a chip system, or a system-on-chip, or the like.

FIG. 17 is a schematic block diagram of a communication system 1700 to an embodiment of this application. As shown in FIG. 17, the communications system 1700 includes a terminal device 1710 and a network device 1720. The terminal device 1710 may be used to implement corresponding functions implemented by the terminal device in the foregoing methods, and the network device 1720 may be used to implement corresponding functions implemented by the network device in the foregoing methods. For brevity, details are not described herein again.

It should be understood that, the processor in embodiments of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor can implement or perform the methods, steps and logical block diagrams disclosed in the embodiments of this application. The general-purpose processor may be a microprocessor, or the processor may be any conventional processor or the like. Steps of the methods disclosed with reference to embodiments of this application may be directly executed and completed by a hardware decoding processor, or may be executed and completed by using a combination of hardware and software modules in the decoding processor. The software module may be located in a mature storage medium in the art, for example, a random access memory, a flash memory, a read-only memory, a programmable read-only memory, an electrically erasable programmable memory, or a register. The storage medium is located in a memory. The processor reads information from the memory, and completes the steps of the foregoing methods in combination with hardware in the processor.

It may be understood that the memory in the embodiment of this application may be a volatile memory or a nonvolatile memory, or may include both a volatile memory and a nonvolatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DR RAM). It should be noted that, the memory in the system and methods described in this specification includes but is not limited to these memories and any memory of another proper type.

It should be understood that, by way of example but not limitative description, for example, the memory in the embodiment of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), a direct rambus random access memory (Direct Rambus RAM, DR RAM), or the like. In other words, the memory in the embodiment of this application includes but is not limited to these memories and any memory of another proper type.

An embodiment of this application further provides a computer-readable storage medium for storing a computer program.

Optionally, the computer-readable storage medium may be applied to a network device in embodiments of this application, and the computer program causes a computer to execute a corresponding procedure implemented by the network device in the methods in embodiments of this application. For brevity, details are not described herein again.

Optionally, the computer-readable storage medium may be applied to a mobile terminal or a terminal device in embodiments of this application, and the computer program causes a computer to execute a corresponding procedure implemented by the mobile terminal or the terminal device in the methods in embodiments of this application. For brevity, details are not described herein again.

An embodiment of this application further provides a computer program product, including computer program instructions.

Optionally, the computer program product may be applied to a network device in embodiments of this application, and the computer program instructions cause a computer to perform a corresponding procedure implemented by the network device in the methods in embodiments of this application. For brevity, details are not described herein again.

Optionally, the computer program product may be applied to a mobile terminal or a terminal device in embodiments of this application, and the computer program instructions cause a computer to perform a corresponding procedure implemented by the mobile terminal or the terminal device in the methods in embodiments of this application. For brevity, details are not described herein again.

An embodiment of this application further provides a computer program.

Optionally, the computer program may be applied to a network device in embodiments of this application. When the computer program runs on a computer, the computer executes a corresponding procedure implemented by the network device in the methods in embodiments of this application. For brevity, details are not described herein again.

Optionally, the computer program may be applied to a mobile terminal/terminal device in an embodiment of this application. When the computer program is run on a computer, the computer is enabled to perform a corresponding procedure implemented by the mobile terminal/terminal device in the methods in embodiments of this application. For brevity, details are not described herein again.

A person of ordinary skill in the art may be aware that, units and algorithm steps in examples described in combination with the embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, the division of units is merely logical function division and may be other division in actual implementation. For example, a plurality of units or components may be combined or integrated into another system, or some features may be ignored or may not be performed. In addition, the displayed or discussed mutual couplings or direct couplings or communication connections may be implemented through some interfaces. The indirect couplings or communication connections between the apparatus or units may be implemented in electronic, mechanical, or other forms.

The units described as separate components may be or may not be physically separated, and the components displayed as units may be or may not be physical units, that is, may be located in one place or distributed on a plurality of network units. Some or all of the units may be selected according to actual requirements to achieve the objectives of the solutions of embodiments.

In addition, functional units in embodiments of this application may be integrated into one processing unit, or each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this application essentially or parts contributing to the prior art or some of the technical solutions may be embodied in a form of a software product. The computer software product is stored in a storage medium, and includes several instructions for instructing a computer device (which may be a personal computer, a server, a network device, or the like) to perform all or some of the steps of the methods described in the embodiments of this application. The foregoing storage medium includes various media that may store a program code, such as a USB flash drive, a mobile hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. An uplink transmission method, wherein the method comprises:
determining, by a terminal device based on a first segment length, a segment time domain window (TDW) corresponding to a target uplink channel, wherein the target uplink channel comprises N uplink channels, the segment TDW is associated with a time interval at which the terminal device performs time domain synchronization and/or frequency domain synchronization, and N is a positive integer; and
sending, by the terminal device, through the target uplink channel based on the segment TDW.

2. The method according to claim 1, wherein a transmission duration of the target uplink channel corresponds to at least one segment TDW, and the sending, by the terminal device, through the target uplink channel based on the segment TDW comprises:
before sending through the target uplink channel based on each of the at least one segment TDW, performing, by the terminal device, time domain synchronization and/or frequency domain synchronization for the segment TDW, wherein a start position of the 1^{st} segment TDW in the at least one segment TDW is a start position of a 1^{st} uplink channel in the N uplink channels.

3. A terminal device, comprising a processor and a memory, wherein the memory is configured to store a computer program, and the processor is configured to invoke and run the computer program stored in the memory to cause the terminal device to perform:
determining, based on a first segment length, a segment time domain window (TDW) corresponding to a target uplink channel, wherein the target uplink channel comprises N uplink channels, the segment TDW is associated with a time interval at which the terminal device performs time domain synchronization and/or frequency domain synchronization, and N is a positive integer; and
sending through the target uplink channel based on the segment TDW.

4. The terminal device according to claim 3, wherein a transmission duration of the target uplink channel corresponds to at least one segment TDW, and the sending through the target uplink channel based on the segment TDW comprises:
before sending through the target uplink channel based on each of the at least one segment TDW, performing time domain synchronization and/or frequency domain synchronization for the segment TDW, wherein a start position of the 1st segment TDW in the at least one segment TDW is a start position of a 1st uplink channel in the N uplink channels.

5. The terminal device according to claim 3, wherein a transmission duration of the target uplink channel corresponds to at least one segment TDW, and each of the at least one segment TDW comprises one or more actual TDWs; and
a start position of the 1st actual TDW in the first segment TDW is a start position of the first segment TDW, and if an event that destroys power consistency and phase continuity occurs, an end position of the 1st actual TDW is a last symbol of an uplink channel corresponding to a time at which the event occurs; and/or
if no event that destroys power consistency and phase continuity occurs, an end position of the 1st actual TDW is an end position of the first segment TDW;
wherein the first segment TDW is one of the at least one segment TDW.

6. The terminal device according to claim 3, wherein a transmission duration of the target uplink channel corresponds to at least one nominal TDW, and each of the at least one nominal TDW comprises one or more segment TDWs;
wherein a start position of the 1st segment TDW in the first nominal TDW is a start position of the first nominal TDW, and the first nominal TDW is one of the at least one nominal TDW.

7. The terminal device according to claim 3, wherein a transmission duration of the target uplink channel corresponds to at least one nominal TDW, and each of the at least one nominal TDW comprises one or more actual TDWs; and
a start position of the 1st actual TDW in the first nominal TDW is a start position of the first nominal TDW, and if an event that destroys power consistency and phase continuity occurs, an end position of the 1st actual TDW is a last symbol of an uplink channel corresponding to a time at which the event occurs; and/or
if no event that destroys power consistency and phase continuity occurs, an end position of the 1st actual TDW is an end position of the first nominal TDW;
wherein the first nominal TDW is one of the at least one nominal TDW.

8. The terminal device according to claim 7, wherein the event that destroys power consistency and phase continuity comprises: that transmissions through an uplink channel in the first nominal TDW is interrupted by one of the segment TDWs.

9. The terminal device according to claim 3, wherein the terminal device prohibits time domain synchronization and/or frequency domain synchronization that is based on at least one of a position, a public timing parameter, or serving satellite ephemeris information of the terminal device within each segment TDW; and/or
the terminal device prohibits timing advance (TA) adjustment that is based on a received timing advance command (TAC) within each segment TDW.

10. The terminal device according to claim 3, wherein when the terminal device is instructed to perform timing advance (TA) adjustment based on the received timing advance command (TAC) within the first segment TDW, the terminal device determines to perform the TA adjustment based on the TAC before sending through the target uplink channel in a second segment TDW;
wherein the first segment TDW is one of a plurality of segment TDWs, and the second segment TDW is located immediately after the first segment TDW.

11. The terminal device according to claim 3, wherein the processor is configured to invoke and run the computer program stored in the memory to cause the terminal device to further perform:
sending capability information, wherein the capability information comprises first capability information and/or second capability information;
wherein the first capability information is used to indicate a minimum time interval at which the terminal device is capable of performing time domain synchronization and/or frequency domain synchronization and/or a maximum time interval at which the terminal device is capable of performing time domain synchronization and/or frequency domain synchronization; and
the second capability information is used to indicate a maximum duration for which the terminal device is capable of maintaining power consistency and phase continuity.

12. A network device, comprising a processor and a memory, wherein the memory is configured to store a computer program, and the processor is configured to invoke and run the computer program stored in the memory to cause the network device to perform:
receiving transmissions through a target uplink channel, wherein the target uplink channel comprises N uplink channels, N is a positive integer, the target uplink channel is transmitted in a segment time domain window (TDW), the segment TDW is determined based on a first segment length, and the segment TDW is associated with a time interval at which a terminal device performs time domain synchronization and/or frequency domain synchronization.

13. The network device according to claim 12, wherein a transmission duration of the target uplink channel corresponds to at least one segment TDW, before determining that the terminal device sends through the target uplink channel based on each of the at least one segment TDW, performing time domain synchronization and/or frequency domain synchronization for the segment TDW, and a start position of the 1st segment TDW in the at least one segment TDW is a start position of a 1st uplink channel in the N uplink channels.

14. The network device according to claim 12, wherein a transmission duration of the target uplink channel corresponds to at least one segment TDW, and each of the at least one segment TDW comprises one or more actual TDWs; and
a start position of the 1st actual TDW in the first segment TDW is a start position of the first segment TDW, and if an event that destroys power consistency and phase continuity occurs, an end position of the 1st actual TDW is a last symbol of an uplink channel corresponding to a time at which the event occurs; and/or
if no event that destroys power consistency and phase continuity occurs, an end position of the 1st actual TDW is an end position of the first segment TDW; wherein the first segment TDW is one of the at least one segment TDW.

15. The network device according to claim 12, wherein a transmission duration of the target uplink channel corresponds to at least one nominal TDW, and each of the at least one nominal TDW comprises one or more segment TDWs;
wherein a start position of the 1st segment TDW in the first nominal TDW is a start position of the first nominal TDW, and the first nominal TDW is one of the at least one nominal TDW.

16. The network device according to claim 12, wherein a transmission duration of the target uplink channel corresponds to at least one nominal TDW, and each of the at least one nominal TDW comprises one or more actual TDWs; and
a start position of the 1st actual TDW in the first nominal TDW is a start position of the first nominal TDW, and if an event that destroys power consistency and phase continuity occurs, an end position of the 1st actual TDW is a last symbol of an uplink channel corresponding to a time at which the event occurs; and/or
if no event that destroys power consistency and phase continuity occurs, an end position of the 1st actual TDW is an end position of the first nominal TDW;
wherein the first nominal TDW is one of the at least one nominal TDW.

17. The network device according to claim 16, wherein the event that destroys power consistency and phase continuity comprises: that transmissions through an uplink channel in the first nominal TDW is interrupted by one of the segment TDWs.

18. The network device according to claim 12, wherein the network device determines that the terminal device does not performing time domain synchronization and/or frequency domain synchronization that are/is based on at least one of a position, a public timing parameter, or serving satellite ephemeris information of the terminal device within each segment TDW; and/or
the network device determines that the terminal device does not perform timing advance (TA) adjustment that is based on a received timing advance command (TAC) within each segment TDW.

19. The network device according to claim 12, wherein the network device sends a timing advance command (TAC) to the terminal device, and if the terminal device is predicted to perform timing advance (TA) adjustment based on the TAC instruction within a first segment TDW, the network device determines that the terminal device performs TA adjustment based on the TAC before sending through the target uplink channel in a second segment TDW;
wherein the first segment TDW is one of the plurality of segment TDWs, and the second segment TDW is located immediately after the first segment TDW.

20. The network device according to claim 12, wherein the processor is configured to invoke and run the computer program stored in the memory to cause the network device to further perform:
receiving capability information sent by the terminal device, wherein the capability information comprises first capability information and/or second capability information;
wherein the first capability information is used to indicate a minimum time interval at which the terminal device is capable of performing time domain synchronization and/or frequency domain synchronization and/or a maximum time interval at which the terminal device is capable of performing time domain synchronization and/or frequency domain synchronization; and
the second capability information is used to indicate a maximum duration for which the terminal device is capable of maintaining power consistency and phase continuity.
